(19) United States
(12) Patent Application Publication
(10) Pub. No.: US 2018/0135833 A1
(43) Pub. Date: May 17, 2018

(54) LIGHTING SYSTEMS GENERATING CONTROLLED AND WAVELENGTH-CONVERTED LIGHT EMISSIONS

(71) Applicant: EcoSense Lighting Inc., Los Angeles, CA (US)

(72) Inventors: Paul Pickard, Acton, CA (US); Raghuram L.V. Petluri, Cerritos, CA (US)

(21) Appl. No.: 15/835,610

(22) Filed: Dec. 8, 2017

Related U.S. Application Data
(63) Continuation of application No. 14/617,849, filed on Feb. 9, 2015, now Pat. No. 9,869,450.
Application No. 14/617,849 is a continuation of application No. PCT/US2016/016972, filed on Feb. 8, 2016.

(51) Int. Cl. F21V 7/04; F21V 13/12; F21V 7/00; F21V 9/08

(52) U.S. Cl. CPC F21V 7/04; F21V 13/12; F21V 9/08; F21Y 2115/10; F21V 7/0091

(57) ABSTRACT

Lighting system including light source having semiconductor light-emitting device configured for emitting light having first spectral power distribution along central axis. System includes volumetric lumiphor located along central axis configured for converting some light emissions having first spectral power distribution into light emissions having second spectral power distribution. System may include visible light reflector having reflective surface and being spaced apart along central axis with volumetric lumiphor between semiconductor light-emitting device and visible light reflector. Reflective surface may be configured for causing portion of light emissions to be reflected by visible light reflector. Exterior surface of volumetric lumiphor may include concave exterior surface configured for receiving a mound-shaped reflective surface of visible light reflector. Volumetric lumiphor may have exterior surface that includes: concave exterior surface forming gap between semiconductor light-emitting device and volumetric lumiphor; or convex or concave exterior surface located away from and surrounding central axis. Related lighting processes.

### CROSS-REFERENCE TO RELATED APPLICATIONS

This application is a continuation of U.S. patent application Ser. No. 14/617,849 filed on Feb. 9, 2015, the entirety of which hereby is incorporated herein by reference.

### BACKGROUND OF THE INVENTION

### 1. Field of the Invention

The present invention relates to the field of lighting systems that include semiconductor light-emitting devices, and processes related to such lighting systems.

### 2. Background of the Invention

Numerous lighting systems that include semiconductor light-emitting devices have been developed. As examples, some of such lighting systems may convert wavelengths and change propagation directions of light emitted by the semiconductor light-emitting devices. Despite the existence of these lighting systems, further improvements are still needed in lighting systems that include semiconductor light-emitting devices, and in processes related to such lighting systems.

### SUMMARY

In an example of an implementation, a lighting system is provided that includes a light source, a visible light reflector, and a volumetric lumiphor. In this example of the lighting system, the light source includes a semiconductor light-emitting device being configured for emitting, along a central axis, light emissions having a first spectral power distribution. The visible light reflector in this example of a lighting system has a reflective surface and is spaced apart along the central axis at a distance away from the semiconductor light-emitting device. Also in this example of the lighting system, the volumetric lumiphor is located along the central axis between the semiconductor light-emitting device and the visible light reflector. Further in this example of the lighting system, the volumetric lumiphor is configured for converting some of the light emissions having the first spectral power distribution into light emissions having a second spectral power distribution being different than the first spectral power distribution. The reflective surface of the visible light reflector in this example of the lighting system is configured for causing a portion of the light emissions having the first and second spectral power distributions to be reflected by the visible light reflector. Additionally in this example of the lighting system, the visible light reflector is configured for permitting another portion of the light emissions having the first and second spectral power distributions to be transmitted through the visible light reflector along the central axis.

In some examples of the lighting system, the volumetric lumiphor may be integral with a visible light reflector.

In further examples of the lighting system, a reflective surface may be configured for causing the portion of the light emissions having the first and second spectral power distributions that are reflected by a visible light reflector to have reflectance values throughout the visible light spectrum being within a range of about 0.80 and about 0.95.

In additional examples of the lighting system, a visible light reflector may be configured for causing an another portion of the light emissions having the first and second spectral power distributions that may be transmitted through the visible light reflector to have transmittance values throughout the visible light spectrum being within a range of about 0.20 and about 0.05.

In further examples of the lighting system, a reflective surface of a visible light reflector may be configured for causing some of the light emissions having the first and second spectral power distributions that are reflected by the visible light reflector to be redirected in a plurality of lateral directions away from the central axis.

In other examples, the lighting system may further include a primary visible light reflector being configured for causing some of the light emissions having the first and second spectral power distributions to be redirected in a plurality of directions intersecting the central axis.

In some examples of the lighting system, the semiconductor light-emitting device may be configured for emitting the light emissions of the first spectral power distribution as having a luminous flux of a first magnitude, and the lighting system may be configured for causing the some of the light emissions that may be redirected in the plurality of directions intersecting the central axis to have a luminous flux of a second magnitude being at least about 50% as great as the first magnitude.

In further examples of the lighting system, the semiconductor light-emitting device may be configured for emitting the light emissions of the first spectral power distribution as having a luminous flux of a first magnitude, and the lighting system may be configured for causing the some of the light emissions that may be redirected in the plurality of directions intersecting the central axis to have a luminous flux of a second magnitude being at least about 80% as great as the first magnitude.

Additional examples of the lighting system may include a primary visible light reflector including a truncated parabolic reflector.

Other examples of the lighting system may include a primary visible light reflector including a truncated conical reflector.

Further examples of the lighting system may include a primary total internal reflection lens being configured for causing some of the light emissions having the first and second spectral power distributions to be redirected in a plurality of directions intersecting the central axis.

In other examples of the lighting system, the semiconductor light-emitting device may be configured for emitting the light emissions of the first spectral power distribution as having a luminous flux of a first magnitude, and the lighting system may be configured for causing some of the light emissions to be redirected in a plurality of directions intersecting the central axis and to have a luminous flux of a second magnitude being at least about 50% as great as the first magnitude.

In some examples of the lighting system, the semiconductor light-emitting device may be configured for emitting the light emissions of the first spectral power distribution as having a luminous flux of a first magnitude, and the lighting system may be configured for causing some of the light emissions to be redirected in a plurality of directions intersecting the central axis and to have a luminous flux of a second magnitude being at least about 80% as great as the first magnitude.

In further examples, the lighting system may include a light guide being configured for causing some of the light emissions having the first and second spectral power distributions to be redirected in a plurality of other directions being different than the lateral directions.

In additional examples, the lighting system may be configured for forming combined light emissions by causing some of the light emissions having the first spectral power distribution to be combined together with some of the light emissions having the second spectral power distribution, and the lighting system may be configured for causing some of the combined light emissions to be emitted from the lighting system in a plurality of directions intersecting the central axis.

In other examples, the lighting system may be configured for causing some of the combined light emissions to be emitted from the lighting system in a plurality of directions diverging away from the central axis.

In some examples, the lighting system may be configured for causing some of the combined light emissions to be emitted from the lighting system in a plurality of directions along the central axis.

In further examples of the lighting system, the semiconductor light-emitting device may be located along the central axis between another visible light reflector and the volumetric lumiphor, and the another visible light reflector may have another reflective surface being configured for causing some of the light emissions having the first and second spectral power distributions to be reflected by the another visible light reflector.

In additional examples of the lighting system, an another reflective surface of another visible light reflector may be configured for causing some of the light emissions having the first and second spectral power distributions to be reflected by the another visible light reflector in a plurality of lateral directions away from the central axis.

In other examples, the lighting system may include a primary visible light reflector being configured for causing some of the light emissions having the first and second spectral power distributions to be redirected in a plurality of directions intersecting the central axis.

In some examples, the lighting system may include a primary total internal reflection lens being configured for causing some of the light emissions having the first and second spectral power distributions to be redirected in a plurality of directions intersecting the central axis.

In further examples, the lighting system may include a light guide being configured for causing some of the light emissions having the first and second spectral power distributions to be redirected in a plurality of other directions being different than the lateral directions.

In other examples of the lighting system, a visible light reflector may have a shape being centered on the central axis.

In some examples of the lighting system, a visible light reflector may have a shape that extends away from the central axis in directions being transverse to the central axis.

In further examples of the lighting system, the shape of a visible light reflector may have a maximum width in the directions transverse to the central axis, and the volumetric lumiphor may have a shape that extends away from the central axis in directions being transverse to the central axis, and the shape of the volumetric lumiphor may have a maximum width in the directions transverse to the central axis being smaller than a maximum width of a visible light reflector.

In other examples of the lighting system, the shape of a visible light reflector may have a maximum width in the directions transverse to the central axis, and the volumetric lumiphor may have a shape that extends away from the central axis in directions being transverse to the central axis, and the shape of the volumetric lumiphor may have a maximum width in the directions transverse to the central axis being equal to or larger than a maximum width of a visible light reflector.

In additional examples of the lighting system, a reflective surface of a visible light reflector may have a distal portion being located at a greatest distance away from the central axis, and the distal portion of the reflective surface may have a beveled edge.

In other examples of the lighting system, a portion of a reflective surface of a visible light reflector may be a planar reflective surface.

In some examples of the lighting system, a portion of a reflective surface of a visible light reflector may face toward the semiconductor light-emitting device and may extend away from the central axis in the directions transverse to the central axis.

In further examples of the lighting system, a portion of a reflective surface of a visible light reflector may face toward the semiconductor light-emitting device, and the volumetric lumiphor may have an exterior surface, and a portion of the exterior surface may face toward the portion of the reflective surface of the visible light reflector.

In other examples of the lighting system, a portion of an exterior surface of the volumetric lumiphor may be configured for permitting entry into the volumetric lumiphor by light emissions that have the first and second spectral power distributions.

In some examples of the lighting system, a portion of a reflective surface of a visible light reflector may be a convex reflective surface facing toward the semiconductor light-emitting device.

In further examples of the lighting system, a shortest distance between the semiconductor light-emitting device and a portion of a reflective surface of a visible light reflector may be located along the central axis.

In other examples of the lighting system, a convex reflective surface of a visible light reflector may be configured for causing some of the light emissions having the first and second spectral power distributions that may be reflected by the visible light reflector to be redirected in a plurality of lateral directions away from the central axis.

In some examples of the lighting system, a portion of a reflective surface of a visible light reflector may be a mound-shaped reflective surface facing toward the semiconductor light-emitting device.

In further examples of the lighting system, the volumetric lumiphor may have an exterior surface, and a portion of the exterior surface may be a concave exterior surface being configured for receiving a mound-shaped reflective surface of a visible light reflector.

In additional examples, the lighting system may be configured for causing some of the light emissions having the first and second spectral power distributions to be emitted from the volumetric lumiphor through a concave exterior surface, and a visible light reflector may be configured for causing some of the light emissions to be reflected by the reflective surface and to enter into the volumetric lumiphor through the concave exterior surface.

In other examples of the lighting system, the volumetric lumiphor may have an exterior surface, wherein a portion of the exterior surface may be a concave exterior surface forming a gap between the semiconductor light-emitting device and the volumetric lumiphor.

In some examples, the lighting system may be configured for causing entry of some of the light emissions from the semiconductor light-emitting device having the first spectral power distribution into the volumetric lumiphor through a concave exterior surface, and the volumetric lumiphor may be configured for causing refraction of some of the light emissions having the first spectral power distribution.

In further examples of the lighting system, the volumetric lumiphor may have an exterior surface, wherein a portion of the exterior surface may be a convex exterior surface surrounded by a concave exterior surface, and the concave exterior surface may form a gap between the semiconductor light-emitting device and the volumetric lumiphor.

In other examples of the lighting system, the volumetric lumiphor may have an exterior surface, wherein a portion of the exterior surface may be a convex exterior surface being located at a distance away from and surrounding the central axis.

In some examples, the lighting system may be configured for causing some of the light emissions having the first and second spectral power distributions to be emitted from the volumetric lumiphor through a convex exterior surface, and the convex exterior surface may be configured for causing refraction of some of the light emissions.

In further examples of the lighting system, the volumetric lumiphor may have an exterior surface, wherein a portion of the exterior surface may be a concave exterior surface being located at a distance away from and surrounding the central axis.

In other examples, the lighting system may be configured for causing some of the light emissions having the first and second spectral power distributions to be emitted from the volumetric lumiphor through a concave exterior surface, and the concave exterior surface may be configured for causing refraction of some of the light emissions.

In some examples of the lighting system, the volumetric lumiphor may include: a phosphor; a quantum dot; a quantum wire; a quantum well; a photonic nanocrystal; a semiconducting nanoparticle; a scintillator; a lumiphoric ink; a lumiphoric organic dye; or a day glow tape.

In further examples of the lighting system, the volumetric lumiphor may be configured for down-converting some of the light emissions of the semiconductor light-emitting device having wavelengths of the first spectral power distribution into light emissions having wavelengths of the second spectral power distribution as being longer than wavelengths of the first spectral power distribution.

In other examples of the lighting system, the semiconductor light-emitting device may be configured for emitting light having a dominant- or peak-wavelength being within a range of between about 380 nanometers and about 530 nanometers.

In some examples of the lighting system, the semiconductor light-emitting device may be configured for emitting light having a color point being greenish-blue, blue, or purplish-blue.

In further examples, the lighting system may further include another semiconductor light-emitting device, and the another semiconductor light-emitting device may be configured for emitting light having a dominant- or peak-wavelength being within a range of between about 380 nanometers and about 530 nanometers.

In other examples of the lighting system, the semiconductor light-emitting device may be configured for emitting light having a dominant- or peak-wavelength being within a range of between about 420 nanometers and about 510 nanometers.

In some examples of the lighting system, the semiconductor light-emitting device may be configured for emitting light having a dominant- or peak-wavelength being within a range of between about 445 nanometers and about 490 nanometers.

In other examples, the lighting system may be configured for causing the light emissions having the first and second spectral power distributions to be combined together forming combined light emissions having a color point with a color rendition index (CRI-Ra including R₁₋₈) being about equal to or greater than 50.

In some examples, the lighting system may be configured for causing the light emissions having the first and second spectral power distributions to be combined together forming combined light emissions having a color point with a color rendition index (CRI-Ra including R₁₋₈) being about equal to or greater than 75.

In further examples, the lighting system may be configured for causing the light emissions having the first and second spectral power distributions to be combined together forming combined light emissions having a color point with a color rendition index (CRI-Ra including R₁₋₈) being about equal to or greater than 95.

In other examples, the lighting system may be configured for causing the light emissions having the first and second spectral power distributions to be combined together forming combined light emissions having a color point with a color rendition index (CRI-R₉) being about equal to or greater than 50.

In some examples, the lighting system may be configured for causing the light emissions having the first and second spectral power distributions to be combined together forming combined light emissions having a color point with a color rendition index (CRI-R₉) being about equal to or greater than 75.

In additional examples, the lighting system may be configured for causing the light emissions having the first and second spectral power distributions to be combined together forming combined light emissions having a color point with a color rendition index (CRI-R₉) being about equal to or greater than 90.

In other examples, the lighting system may be configured for forming combined light emissions by causing some of the light emissions having the first spectral power distribution to be combined together with some of the light emissions having the second spectral power distribution, and the semiconductor light-emitting device and the volumetric lumiphor may be configured for causing the combined light emissions to have a color point being within a distance of about equal to or less than +/−0.009 delta(uv) away from a Planckian—black-body locus throughout a spectrum of correlated color temperatures (CCTs) within a range of between about 1800K and about 6500K.

In some examples, the lighting system may be configured for forming combined light emissions by causing some of the light emissions having the first spectral power distribution to be combined together with some of the light emissions having the second spectral power distribution, and the semiconductor light-emitting device and the volumetric lumiphor may be configured for causing the combined light emissions to have a color point being below a Planckian—black-body locus by a distance of about equal to or less than 0.009 delta(uv) throughout a spectrum of correlated color temperatures (CCTs) within a range of between about 1800K and about 6500K.

In further examples of the lighting system, the volumetric lumiphor may be configured for down-converting some of the light emissions of the semiconductor light-emitting device having wavelengths of the first spectral power distribution into light emissions having wavelengths of the second spectral power distribution, and the second spectral power distribution may have a perceived color point being within a range of between about 491 nanometers and about 575 nanometers.

In other examples of the lighting system, the volumetric lumiphor may include a first lumiphor that generates light emissions having a perceived color point being within a range of between about 491 nanometers and about 575 nanometers, and the first lumiphor may include: a phosphor; a quantum dot; a quantum wire; a quantum well; a photonic nanocrystal; a semiconducting nanoparticle; a scintillator; a lumiphoric ink; a lumiphoric organic dye; or a day glow tape.

In some examples of the lighting system, the volumetric lumiphor may be configured for down-converting some of the light emissions of the semiconductor light-emitting device having the first spectral power distribution into light emissions having wavelengths of a third spectral power distribution being different than the first and second spectral power distributions; and the third spectral power distribution may have a perceived color point being within a range of between about 610 nanometers and about 670 nanometers.

In further examples of the lighting system, the volumetric lumiphor may include a second lumiphor that may generate light emissions having a perceived color point being within a range of between about 610 nanometers and about 670 nanometers, and the second lumiphor may include: a phosphor; a quantum dot; a quantum wire; a quantum well; a photonic nanocrystal; a semiconducting nanoparticle; a scintillator; a lumiphoric ink; a lumiphoric organic dye; or a day glow tape.

In additional examples, the lighting system may be configured for causing light emissions having first, second and third spectral power distributions to be combined together to form combined light emissions having a color point with a color rendition index (CRI-Ra including R₁₋₈) being about equal to or greater than 50.

In other examples, the lighting system may be configured for causing light emissions having first, second and third spectral power distributions to be combined together to form combined light emissions having a color point with a color rendition index (CRI-Ra including R₁₋₈) being about equal to or greater than 75.

In some examples, the lighting system may be configured for causing light emissions having first, second and third spectral power distributions to be combined together to form combined light emissions having a color point with a color rendition index (CRI-Ra including R₁₋₈) being about equal to or greater than 95.

In further examples, the lighting system may be configured for causing light emissions having first, second and third spectral power distributions to be combined together to form combined light emissions having a color point with a color rendition index (CRI-R₉) being about equal to or greater than 50.

In other examples, the lighting system may be configured for causing light emissions having first, second and third spectral power distributions to be combined together to form combined light emissions having a color point with a color rendition index (CRI-R₉) being about equal to or greater than 75.

In some examples, the lighting system may be configured for causing light emissions having first, second and third spectral power distributions to be combined together to form combined light emissions having a color point with a color rendition index (CRI-R₉) being about equal to or greater than 90.

In further examples of the lighting system, the volumetric lumiphor may be configured for causing light emissions having first, second and third spectral power distributions to be combined together to form combined light emissions having a color point being within a distance of about equal to or less than +/−0.009 delta(uv) away from a Planckian—black-body locus throughout a spectrum of correlated color temperatures (CCTs) within a range of between about 1800K and about 6500K.

In additional examples of the lighting system, the volumetric lumiphor may be configured for causing light emissions having first, second and third spectral power distributions to be combined together to form combined light emissions having a color point being below a Planckian—black-body locus by a distance of about equal to or less than 0.009 delta(uv) throughout a spectrum of correlated color temperatures (CCTs) within a range of between about 1800K and about 6500K.

In other examples of the lighting system, a first lumiphor may include a first quantum material, and a second lumiphor may include a different second quantum material, and each one of the first and second quantum materials may have a spectral power distribution for light absorption being separate from both of the second and third spectral power distributions.

In another example of an implementation, a lighting system is provided that includes a light source and a volumetric lumiphor. The light source in this example of the lighting system includes a semiconductor light-emitting device being configured for emitting, along a central axis, light emissions having a first spectral power distribution. Also in this example of the lighting system, the volumetric lumiphor is located along the central axis and is configured for converting some of the light emissions having the first spectral power distribution into light emissions having a second spectral power distribution being different than the first spectral power distribution. The volumetric lumiphor in this example of the lighting system has an exterior surface, wherein a portion of the exterior surface of the volumetric lumiphor is a concave exterior surface forming a gap between the semiconductor light-emitting device and the volumetric lumiphor. In this example, the lighting system is configured for causing entry of some of the light emissions from the semiconductor light-emitting device having the first spectral power distribution into the volumetric lumiphor through the concave exterior surface. Further in this example of the lighting system, the volumetric lumiphor is configured for causing refraction of some of the light emissions having the first spectral power distribution. In some examples, the lighting system may include a visible light reflector having a reflective surface, and the volumetric lumiphor may be located along the central axis between the semiconductor light-emitting device and the visible light reflector. In further examples of the lighting system, another portion of the exterior surface of the volumetric lumiphor may be a convex exterior surface, and the convex exterior surface may be surrounded by the concave exterior surface.

In a further example of an implementation, a lighting system is provided that includes a light source and a volumetric lumiphor. The light source in this example of the lighting system includes a semiconductor light-emitting device being configured for emitting, along a central axis, light emissions having a first spectral power distribution. Also in this example of the lighting system, the volumetric lumiphor is located along the central axis and is configured for converting some of the light emissions having the first spectral power distribution into light emissions having a second spectral power distribution being different than the first spectral power distribution. The volumetric lumiphor in this example of the lighting system has an exterior surface, wherein a portion of the exterior surface of the volumetric lumiphor is a convex exterior surface being located at a distance away from and surrounding the central axis. In this example, the lighting system is configured for causing some of the light emissions having the first and second spectral power distributions to enter into and be emitted from the volumetric lumiphor through the convex exterior surface. Additionally in this example of the lighting system, the volumetric lumiphor is configured for causing refraction of some of the light emissions. In some examples, the lighting system may further include a visible light reflector having a reflective surface, and the volumetric lumiphor may be located along the central axis between the semiconductor light-emitting device and the visible light reflector.

In an additional example of an implementation, a lighting system is provided that includes a light source and a volumetric lumiphor. The light source in this example of the lighting system includes a semiconductor light-emitting device being configured for emitting, along a central axis, light emissions having a first spectral power distribution. Also in this example of the lighting system, the volumetric lumiphor is located along the central axis and is configured for converting some of the light emissions having the first spectral power distribution into light emissions having a second spectral power distribution being different than the first spectral power distribution. The volumetric lumiphor in this example of the lighting system has an exterior surface, wherein a portion of the exterior surface of the volumetric lumiphor is a concave exterior surface being located at a distance away from and surrounding the central axis. In this example, the lighting system is configured for causing some of the light emissions having the first and second spectral power distributions to enter into and be emitted from the volumetric lumiphor through the concave exterior surface. Additionally in this example of the lighting system, the volumetric lumiphor is configured for causing refraction of some of the light emissions. In some examples, the lighting system may further include a visible light reflector having a reflective surface, and the volumetric lumiphor may be located along the central axis between the semiconductor light-emitting device and the visible light reflector.

As a further example of an implementation, a lighting process is provided that includes providing a lighting system including: a light source that includes a semiconductor light-emitting device being configured for emitting, along a central axis, light emissions having a first spectral power distribution; and a volumetric lumiphor being located along the central axis and being configured for converting some of the light emissions having the first spectral power distribution into light emissions having a second spectral power distribution being different than the first spectral power distribution, the volumetric lumiphor having a concave exterior surface forming a gap between the semiconductor light-emitting device and the volumetric lumiphor. This example of the lighting process further includes: causing the semiconductor light-emitting device to emit light emissions having the first spectral power distribution; and causing some of the light emissions having the first spectral power distribution to enter into the volumetric lumiphor through the concave exterior surface and to be refracted by the volumetric lumiphor.

As an additional example of an implementation, a lighting process is provided that includes providing a lighting system including: a light source that includes a semiconductor light-emitting device being configured for emitting, along a central axis, light emissions having a first spectral power distribution; and a volumetric lumiphor being located along the central axis and being configured for converting some of the light emissions having the first spectral power distribution into light emissions having a second spectral power distribution being different than the first spectral power distribution, the volumetric lumiphor having a convex exterior surface being located at a distance away from and surrounding the central axis. This example of the lighting process further includes: causing the semiconductor light-emitting device to emit light emissions having the first spectral power distribution; and causing some of the light emissions having the first spectral power distribution to enter into and to be emitted from the volumetric lumiphor through the convex exterior surface, and to be refracted by the volumetric lumiphor.

In another example of an implementation, a lighting process is provided that includes providing a lighting system including: a light source that includes a semiconductor light-emitting device being configured for emitting, along a central axis, light emissions having a first spectral power distribution; and a volumetric lumiphor being located along the central axis and being configured for converting some of the light emissions having the first spectral power distribution into light emissions having a second spectral power distribution being different than the first spectral power distribution, the volumetric lumiphor having a concave exterior surface being located at a distance away from and surrounding the central axis. This example of the lighting process further includes: causing the semiconductor light-emitting device to emit light emissions having the first spectral power distribution; and causing some of the light emissions having the first spectral power distribution to enter into and to be emitted from the volumetric lumiphor through the concave exterior surface, and to be refracted by the volumetric lumiphor.

As a further example of an implementation, a lighting process is provided that includes providing a lighting system including: a light source that includes a semiconductor light-emitting device being configured for emitting, along a central axis, light emissions having a first spectral power distribution; a volumetric lumiphor being located along the central axis and being configured for converting some of the light emissions having the first spectral power distribution into light emissions having a second spectral power distribution being different than the first spectral power distribution; and a visible light reflector having a reflective surface and being spaced apart along the central axis at a distance away from the semiconductor light-emitting device, with the volumetric lumiphor being located along the central axis between the semiconductor light-emitting device and the visible light reflector. This example of the lighting process further includes: causing the semiconductor light-emitting device to emit light emissions having the first spectral power distribution; and causing the reflective surface of the visible light reflector to reflect a portion of the light emissions having the first and second spectral power distributions. In some examples, the lighting process may further include permitting another portion of the light emissions to be transmitted through the visible light reflector along the central axis. In additional examples of the lighting process, the providing the lighting system may further include: providing the reflective surface of the visible light reflector as including a mound-shaped reflective surface; and providing the exterior surface of the volumetric lumiphor as including a concave exterior surface configured for receiving the mound-shaped reflective surface of the visible light reflector.

Other systems, processes, features and advantages of the invention will be or will become apparent to one with skill in the art upon examination of the following figures and detailed description. It is intended that all such additional systems, processes, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a schematic top view showing an example of an implementation of a lighting system.

FIG. 2 is a schematic cross-sectional view taken along the line 2-2 showing the example of the lighting system.

FIG. 3 is a schematic top view showing another example of an implementation of a lighting system.

FIG. 4 is a schematic cross-sectional view taken along the line 4-4 showing the another example of the lighting system.

FIG. 5 is a schematic top view showing a further example of an implementation of a lighting system.

FIG. 6 is a schematic cross-sectional view taken along the line 6-6 showing the further example of the lighting system.

FIG. 7 is a schematic top view showing an additional example of an implementation of a lighting system.

FIG. 8 is a schematic cross-sectional view taken along the line 8-8 showing the additional example of the lighting system.

FIG. 9 is a flow chart showing an example of an implementation of a lighting process.

### DETAILED DESCRIPTION

Various lighting systems and processes that utilize semiconductor light-emitting devices have been designed. Many such lighting systems and processes exist that are capable of emitting light along a central axis. However, existing lighting systems and processes often have demonstrably failed to provide controlled light emissions having a perceived uniform color point and brightness; and often have generated light emissions being perceived as having aesthetically-unpleasing glare. Many lighting systems and processes also exist that utilize lumiphors for converting light emissions having a first spectral power distribution into light emissions having a second spectral power distribution being different than the first spectral power distribution. However, existing lighting systems and processes often have demonstrably failed to protect the lumiphors from heat-induced degradation that may be caused by heat generated during light emissions by the semiconductor light-emitting devices, which may result in the light emissions being perceived as having unstable color points and non-uniform brightness.

Lighting systems accordingly are provided herein, including a light source and a volumetric lumiphor. The light source includes a semiconductor light-emitting device being configured for emitting, along a central axis, light emissions having a first spectral power distribution. The volumetric lumiphor is located along the central axis and is configured for converting some of the light emissions having the first spectral power distribution into light emissions having a second spectral power distribution being different than the first spectral power distribution. In some examples, the lighting system may further include a visible light reflector having a reflective surface, with the volumetric lumiphor being located along the central axis between the semiconductor light-emitting device and the visible light reflector. In those examples of the lighting system, the reflective surface may be configured for causing a portion of the light emissions having the first and second spectral power distributions to be reflected by the visible light reflector. Further in those examples, the visible light reflector may be configured for permitting another portion of the light emissions having the first and second spectral power distributions to be transmitted through the visible light reflector along the central axis. In additional examples of the lighting system, the volumetric lumiphor may have an exterior surface wherein a portion of the exterior surface is a concave exterior surface forming a gap between the semiconductor light-emitting device and the volumetric lumiphor. In other examples of the lighting system, the volumetric lumiphor may have an exterior surface wherein a portion of the exterior surface is a convex exterior surface being located at a distance away from and surrounding the central axis. In further examples of the lighting system, the volumetric lumiphor may have an exterior surface wherein a portion of the exterior surface is a concave exterior surface being located at a distance away from and surrounding the central axis. Lighting processes also accordingly are provided herein, which include providing a lighting system. The lighting processes further include causing a semiconductor light-emitting device of the lighting system to emit light emissions having a first spectral power distribution. In some examples, the lighting process may include causing a reflective surface of a visible light reflector to reflect a portion of the light emissions; and may additionally include permitting another portion of the light emissions to be transmitted through the visible light reflector along the central axis.

The lighting systems provided herein may, for example, produce light emissions wherein the directions of propagation of a portion of the light emissions constituting at least about 50% or at least about 80% of a total luminous flux of the semiconductor light-emitting device or devices are redirected by and therefore controlled by the lighting systems. The controlled light emissions from these lighting systems may have, as examples: a perceived uniform color point; a perceived uniform brightness; a perceived uniform appearance; and a perceived aesthetically-pleasing appearance without perceived glare. The controlled light emissions from these lighting systems may further, as examples, be utilized in generating specialty lighting effects being perceived as having a more uniform appearance in applications such as wall wash, corner wash, and floodlight. The lighting systems provided herein may further, for example, protect the lumiphors of the lighting systems from heat-induced degradation that may be caused by heat generated during light emissions by the semiconductor light-emitting devices, resulting in, as examples: a stable color point; and a long-lasting stable brightness. The light emissions from these lighting systems may, for the foregoing reasons, accordingly be perceived as having, as examples: a uniform color point; a uniform brightness; a uniform appearance; an aesthetically-pleasing appearance without perceived glare; a stable color point; and a long-lasting stable brightness.

The following definitions of terms, being stated as applying “throughout this specification”, are hereby deemed to be incorporated throughout this specification, including but not limited to the Summary, Brief Description of the Figures, Detailed Description, and Claims.

Throughout this specification, the term “semiconductor” means: a substance, examples including a solid chemical element or compound, that can conduct electricity under some conditions but not others, making the substance a good medium for the control of electrical current.

Throughout this specification, the term “semiconductor light-emitting device” (also being abbreviated as “SLED”) means: a light-emitting diode; an organic light-emitting diode; a laser diode; or any other light-emitting device having one or more layers containing inorganic and/or organic semiconductor(s). Throughout this specification, the term “light-emitting diode” (herein also referred to as an “LED”) means: a two-lead semiconductor light source having an active pn-junction. As examples, an LED may include a series of semiconductor layers that may be epitaxially grown on a substrate such as, for example, a substrate that includes sapphire, silicon, silicon carbide, gallium nitride or gallium arsenide. Further, for example, one or more semiconductor p-n junctions may be formed in these epitaxial layers. When a sufficient voltage is applied across the p-n junction, for example, electrons in the n-type semiconductor layers and holes in the p-type semiconductor layers may flow toward the p-n junction. As the electrons and holes flow toward each other, some of the electrons may recombine with corresponding holes, and emit photons. The energy release is called electroluminescence, and the color of the light, which corresponds to the energy of the photons, is determined by the energy band gap of the semiconductor. As examples, a spectral power distribution of the light generated by an LED may generally depend on the particular semiconductor materials used and on the structure of the thin epitaxial layers that make up the “active region” of the device, being the area where the light is generated. As examples, an LED may have a light-emissive electroluminescent layer including an inorganic semiconductor, such as a Group III-V semiconductor, examples including: gallium nitride; silicon; silicon carbide; and zinc oxide. Throughout this specification, the term “organic light-emitting diode” (herein also referred to as an “OLED”) means: an LED having a light-emissive electroluminescent layer including an organic semiconductor, such as small organic molecules or an organic polymer. It is understood throughout this specification that a semiconductor light-emitting device may include: a non-semiconductor-substrate or a semiconductor-substrate; and may include one or more electrically-conductive contact layers. Further, it is understood throughout this specification that an LED may include a substrate formed of materials such as, for example: silicon carbide; sapphire; gallium nitride; or silicon. It is additionally understood throughout this specification that a semiconductor light-emitting device may have a cathode contact on one side and an anode contact on an opposite side, or may alternatively have both contacts on the same side of the device.

Further background information regarding semiconductor light-emitting devices is provided in the following documents, the entireties of all of which hereby are incorporated by reference herein: U.S. Pat. Nos. 7,564,180; 7,456,499; 7,213,940; 7,095,056; 6,958,497; 6,853,010; 6,791,119; 6,600,175; 6,201,262; 6,187,606; 6,120,600; 5,912,477; 5,739,554; 5,631,190; 5,604,135; 5,523,589; 5,416,342; 5,393,993; 5,359,345; 5,338,944; 5,210,051; 5,027,168; 5,027,168; 4,966,862; and 4,918,497; and U.S. Patent Application Publication Nos. 2014/0225511; 2014/0078715; 2013/0241392; 2009/0184616; 2009/0080185; 2009/0050908; 2009/0050907; 2008/0308825; 2008/0198112; 2008/0179611; 2008/0173884; 2008/0121921; 2008/0012036; 2007/0253209; 2007/0223219; 2007/0170447; 2007/0158668; 2007/0139923; and 2006/0221272.

Throughout this specification, the term “spectral power distribution” means: the emission spectrum of the one or more wavelengths of light emitted by a semiconductor light-emitting device. Throughout this specification, the term “peak wavelength” means: the wavelength where the spectral power distribution of a semiconductor light-emitting device reaches its maximum value as detected by a photo-detector. As an example, an LED may be a source of nearly monochromatic light and may appear to emit light having a single color. Thus, the spectral power distribution of the light emitted by such an LED may be centered about its peak wavelength. As examples, the “width” of the spectral power distribution of an LED may be within a range of between about 10 nanometers and about 30 nanometers, where the width is measured at half the maximum illumination on each side of the emission spectrum. Throughout this specification, the term “full-width-half-maximum” (“FWHM”) means: the width of the spectral power distribution of a semiconductor light-emitting device measured at half the maximum illumination on each side of its emission spectrum. Throughout this specification, the term “dominant wavelength” means: the wavelength of monochromatic light that has the same apparent color as the light emitted by a semiconductor light-emitting device, as perceived by the human eye. As an example, since the human eye perceives yellow and green light better than red and blue light, and because the light emitted by a semiconductor light-emitting device may extend across a range of wavelengths, the color perceived (i.e., the dominant wavelength) may differ from the peak wavelength.

Throughout this specification, the term “luminous flux”, also referred to as “luminous power”, means: the measure in lumens of the perceived power of light, being adjusted to reflect the varying sensitivity of the human eye to different wavelengths of light. Throughout this specification, the term “radiant flux” means: the measure of the total power of electromagnetic radiation without being so adjusted. Throughout this specification, the term “central axis” means a direction along which the light emissions of a semiconductor light-emitting device have a greatest radiant flux. It is understood throughout this specification that light emissions “along a central axis” means light emissions that: include light emissions in the direction of the central axis; and may further include light emissions in a plurality of other generally similar directions.

Throughout this specification, the term “color bin” means: the designated empirical spectral power distribution and related characteristics of a particular semiconductor light-emitting device. For example, individual light-emitting diodes (LEDs) are typically tested and assigned to a designated color bin (i.e., “binned”) based on a variety of characteristics derived from their spectral power distribution. As an example, a particular LED may be binned based on the value of its peak wavelength, being a common metric to characterize the color aspect of the spectral power distribution of LEDs. Examples of other metrics that may be utilized to bin LEDs include: dominant wavelength; and color point.

Throughout this specification, the term “luminescent” means: characterized by absorption of electromagnetic radiation (e.g., visible light, UV light or infrared light) causing the emission of light by, as examples: fluorescence; and phosphorescence. Throughout this specification, the term “object” means a material article or device. Throughout this specification, the term “surface” means an exterior boundary of an object. Throughout this specification, the term “incident visible light” means visible light that propagates in one or more directions towards a surface. Throughout this specification, the term “reflective surface” means a surface of an object that causes incident visible light, upon reaching the surface, to then propagate in one or more different directions away from the surface without passing through the object. Throughout this specification, the term “planar reflective surface” means a generally flat reflective surface.

Throughout this specification, the term “reflectance” means a fraction of a radiant flux of incident visible light having a specified wavelength that is caused by a reflective surface of an object to propagate in one or more different directions away from the surface without passing through the object. Throughout this specification, the term “reflected light” means the incident visible light that is caused by a reflective surface to propagate in one or more different directions away from the surface without passing through the object. Throughout this specification, the term “Lambertian reflectance” means diffuse reflectance of visible light from a surface, in which the reflected light has uniform radiant flux in all of the propagation directions. Throughout this specification, the term “specular reflectance” means mirror-like reflection of visible light from a surface, in which light from a single incident direction is reflected into a single propagation direction. Throughout this specification, the term “spectrum of reflectance values” means a spectrum of values of fractions of radiant flux of incident visible light, the values corresponding to a spectrum of wavelength values of visible light, that are caused by a reflective surface to propagate in one or more different directions away from the surface without passing through the object. Throughout this specification, the term “transmittance” means a fraction of a radiant flux of incident visible light having a specified wavelength that is permitted by a reflective surface to pass through the object having the reflective surface. Throughout this specification, the term “transmitted light” means the incident visible light that is permitted by a reflective surface to pass through the object having the reflective surface. Throughout this specification, the term “spectrum of transmittance values” means a spectrum of values of fractions of radiant flux of incident visible light, the values corresponding to a spectrum of wavelength values of visible light, that are permitted by a reflective surface to pass through the object having the reflective surface. Throughout this specification, the term “absorbance” means a fraction of a radiant flux of incident visible light having a specified wavelength that is permitted by a reflective surface to pass through the reflective surface and is absorbed by the object having the reflective surface. Throughout this specification, the term “spectrum of absorbance values” means a spectrum of values of fractions of radiant flux of incident visible light, the values corresponding to a spectrum of wavelength values of visible light, that are permitted by a reflective surface to pass through the reflective surface and are absorbed by the object having the reflective surface. Throughout this specification, it is understood that a reflective surface, or an object, may have a spectrum of reflectance values, and a spectrum of transmittance values, and a spectrum of absorbance values. The spectra of reflectance values, absorbance values, and transmittance values of a reflective surface or of an object may be measured, for example, utilizing an ultraviolet-visible-near infrared (UV-VIS-NIR) spectrophotometer. Throughout this specification, the term “visible light reflector” means an object having a reflective surface. In examples, a visible light reflector may be selected as having a reflective surface characterized by light reflections that are more Lambertian than specular.

Throughout this specification, the term “lumiphor” means: a medium that includes one or more luminescent materials being positioned to absorb light that is emitted at a first spectral power distribution by a semiconductor light-emitting device, and to re-emit light at a second spectral power distribution in the visible or ultra violet spectrum being different than the first spectral power distribution, regardless of the delay between absorption and re-emission. Lumiphors may be categorized as being down-converting, i.e., a material that converts photons to a lower energy level (longer wavelength); or up-converting, i.e., a material that converts photons to a higher energy level (shorter wavelength). As examples, a luminescent material may include: a phosphor; a quantum dot; a quantum wire; a quantum well; a photonic nanocrystal; a semiconducting nanoparticle; a scintillator; a lumiphoric ink; a lumiphoric organic dye; a day glow tape; a phosphorescent material; or a fluorescent material. Throughout this specification, the term “quantum material” means any luminescent material that includes: a quantum dot; a quantum wire; or a quantum well. Some quantum materials may absorb and emit light at spectral power distributions having narrow wavelength ranges, for example, wavelength ranges having spectral widths being within ranges of between about 25 nanometers and about 50 nanometers. In examples, two or more different quantum materials may be included in a lumiphor, such that each of the quantum materials may have a spectral power distribution for light emissions that may not overlap with a spectral power distribution for light absorption of any of the one or more other quantum materials. In these examples, cross-absorption of light emissions among the quantum materials of the lumiphor may be minimized. As examples, a lumiphor may include one or more layers or bodies that may contain one or more luminescent materials that each may be: (1) coated or sprayed directly onto an semiconductor light-emitting device; (2) coated or sprayed onto surfaces of a lens or other elements of packaging for an semiconductor light-emitting device; (3) dispersed in a matrix medium; or (4) included within a clear encapsulant (e.g., an epoxy-based or silicone-based curable resin or glass or ceramic) that may be positioned on or over an semiconductor light-emitting device. A lumiphor may include one or multiple types of luminescent materials. Other materials may also be included with a lumiphor such as, for example, fillers, diffusants, colorants, or other materials that may as examples improve the performance of or reduce the overall cost of the lumiphor. In examples where multiple types of luminescent materials may be included in a lumiphor, such materials may, as examples, be mixed together in a single layer or deposited sequentially in successive layers.

Throughout this specification, the term “volumetric lumiphor” means a lumiphor being distributed in an object having a shape including defined exterior surfaces. In some examples, a volumetric lumiphor may be formed by dispersing a lumiphor in a volume of a matrix medium having suitable spectra of visible light transmittance values and visible light absorbance values. As examples, such spectra may be affected by a thickness of the volume of the matrix medium, and by a concentration of the lumiphor being distributed in the volume of the matrix medium. In examples, the matrix medium may have a composition that includes polymers or oligomers of: a polycarbonate; a silicone; an acrylic; a glass; a polystyrene; or a polyester such as polyethylene terephthalate. Throughout this specification, the term “remotely-located lumiphor” means a lumiphor being spaced apart at a distance from and positioned to receive light that is emitted by a semiconductor light-emitting device.

Throughout this specification, the term “light-scattering particles” means small particles formed of a non-luminescent, non-wavelength-converting material. In some examples, a volumetric lumiphor may include light-scattering particles being dispersed in the volume of the matrix medium for causing some of the light emissions having the first spectral power distribution to be scattered within the volumetric lumiphor. As an example, causing some of the light emissions to be so scattered within the matrix medium may cause the luminescent materials in the volumetric lumiphor to absorb more of the light emissions having the first spectral power distribution. In examples, the light-scattering particles may include: rutile titanium dioxide; anatase titanium dioxide; barium sulfate; diamond; alumina; magnesium oxide; calcium titanate; barium titanate; strontium titanate; or barium strontium titanate. In examples, light-scattering particles may have particle sizes being within a range of about 0.01 micron (10 nanometers) and about 2.0 microns (2,000 nanometers).

In some examples, a visible light reflector may be formed by dispersing light-scattering particles having a first index of refraction in a volume of a matrix medium having a second index of refraction being suitably different from the first index of refraction for causing the volume of the matrix medium with the dispersed light-scattering particles to have suitable spectra of reflectance values, transmittance values, and absorbance values for functioning as a visible light reflector. As examples, such spectra may be affected by a thickness of the volume of the matrix medium, and by a concentration of the light-scattering particles being distributed in the volume of the matrix medium, and by physical characteristics of the light-scattering particles such as the particle sizes and shapes, and smoothness or roughness of exterior surfaces of the particles. In an example, the smaller the difference between the first and second indices of refraction, the more light-scattering particles may need to be dispersed in the volume of the matrix medium to achieve a given amount of light-scattering. As examples, the matrix medium for forming a visible light reflector may have a composition that includes polymers or oligomers of: a polycarbonate; a silicone; an acrylic; a glass; a polystyrene; or a polyester such as polyethylene terephthalate. In further examples, the light-scattering particles may include: rutile titanium dioxide; anatase titanium dioxide; barium sulfate; diamond; alumina; magnesium oxide; calcium titanate; barium titanate; strontium titanate; or barium strontium titanate. In other examples, a visible light reflector may include a reflective polymeric or metallized surface formed on a visible light-transmissive polymeric or metallic object such as, for example, a volume of a matrix medium. Additional examples of visible light reflectors may include microcellular foamed polyethylene terephthalate sheets (“MCPET”). Suitable visible light reflectors may be commercially available under the trade names White Optics® and MIRO® from WhiteOptics LLC, 243-G Quigley Blvd., New Castle, Del. 19720 USA. Suitable MCPET visible light reflectors may be commercially available from the Furukawa Electric Co., Ltd., Foamed Products Division, Tokyo, Japan. Additional suitable visible light reflectors may be commercially available from CVI Laser Optics, 200 Dorado Place SE, Albuquerque, N. Mex. 87123 USA.

In further examples, a volumetric lumiphor and a visible light reflector may be integrally formed. As examples, a volumetric lumiphor and a visible light reflector may be integrally formed in respective layers of a volume of a matrix medium, including a layer of the matrix medium having a dispersed lumiphor, and including another layer of the same or a different matrix medium having light-scattering particles being suitably dispersed for causing the another layer to have suitable spectra of reflectance values, transmittance values, and absorbance values for functioning as the visible light reflector. In other examples, an integrally-formed volumetric lumiphor and visible light reflector may incorporate any of the further examples of variations discussed above as to separately-formed volumetric lumiphors and visible light reflectors.

Throughout this specification, the term “phosphor” means: a material that exhibits luminescence when struck by photons. Examples of phosphors that may utilized include: CaAlSiN₃:Eu, SrAlSiN₃:Eu, CaAlSiN₃:Eu, Ba₃Si₆O₁₂N₂:Eu, Ba₂SiO₄:Eu, Sr₂SiO₄:Eu, Ca₂SiO₄:Eu, Ca₃Sc₂Si₃O₁₂:Ce, Ca₃Mg₂Si₃O₁₂:Ce, CaSc₂O₄:Ce, CaSi₂O₂N₂:Eu, SrSi₂O₂N₂:Eu, BaSi₂O₂N₂:Eu, Ca₅(PO₄)₃Cl:Eu, Ba₅(PO₄)₃Cl:Eu, Cs₂CaP₂O₇, Cs₂SrP₂O₇, SrGa₂S₄:Eu, Lu₃Al₅O₁₂:Ce, Ca₈Mg(SiO₄)₄Cl₂:Eu, Sr₈Mg(SiO₄)₄Cl₂:Eu, La₃Si₆N₁₁:Ce, Y₃Al₅O₁₂:Ce, Y₃Ga₅O₁₂:Ce, Gd₃Al₅O₁₂:Ce, Gd₃Ga₅O₁₂:Ce, Tb₃Al₅O₁₂:Ce, Tb₃Ga₅O₁₂:Ce, Lu₃Ga₅O₁₂:Ce, (SrCa)AlSiN₃:Eu, LuAG:Ce, (Y,Gd)₂Al₅)₁₂:Ce, CaS:Eu, SrS:Eu, SrGa₂S₄:E₄, Ca₂(Sc,Mg)₂SiO₁₂:Ce, Ca₂Sc₂Si₂)₁₂:C2, Ca₂Sc₂O₄:Ce, Ba₂Si₆O₁₂N₂:Eu, (Sr,Ca)AlSiN₂:Eu, and CaAlSiN₂:Eu.

Throughout this specification, the term “quantum dot” means: a nanocrystal made of semiconductor materials that are small enough to exhibit quantum mechanical properties, such that its excitons are confined in all three spatial dimensions.

Throughout this specification, the term “quantum wire” means: an electrically conducting wire in which quantum effects influence the transport properties.

Throughout this specification, the term “quantum well” means: a thin layer that can confine (quasi-)particles (typically electrons or holes) in the dimension perpendicular to the layer surface, whereas the movement in the other dimensions is not restricted.

Throughout this specification, the term “photonic nanocrystal” means: a periodic optical nanostructure that affects the motion of photons, for one, two, or three dimensions, in much the same way that ionic lattices affect electrons in solids.

Throughout this specification, the term “semiconducting nanoparticle” means: a particle having a dimension within a range of between about 1 nanometer and about 100 nanometers, being formed of a semiconductor.

Throughout this specification, the term “scintillator” means: a material that fluoresces when struck by photons.

Throughout this specification, the term “lumiphoric ink” means: a liquid composition containing a luminescent material. For example, a lumiphoric ink composition may contain semiconductor nanoparticles. Examples of lumiphoric ink compositions that may be utilized are disclosed in Cao et al., U.S. Patent Application Publication No. 20130221489 published on Aug. 29, 2013, the entirety of which hereby is incorporated herein by reference.

Throughout this specification, the term “lumiphoric organic dye” means an organic dye having luminescent up-converting or down-converting activity. As an example, some perylene-based dyes may be suitable.

Throughout this specification, the term “day glow tape” means: a tape material containing a luminescent material.

Throughout this specification, the term “CIE 1931 XY chromaticity diagram” means: the 1931 International Commission on Illumination two-dimensional chromaticity diagram, which defines the spectrum of perceived color points of visible light by (x, y) pairs of chromaticity coordinates that fall within a generally U-shaped area that includes all of the hues perceived by the human eye. Each of the x and y axes of the CIE 1931 XY chromaticity diagram has a scale of between 0.0 and 0.8. The spectral colors are distributed around the perimeter boundary of the chromaticity diagram, the boundary encompassing all of the hues perceived by the human eye. The perimeter boundary itself represents maximum saturation for the spectral colors. The CIE 1931 XY chromaticity diagram is based on the three dimensional CIE 1931 XYZ color space. The CIE 1931 XYZ color space utilizes three color matching functions to determine three corresponding tristimulus values which together express a given color point within the CIE 1931 XYZ three dimensional color space. The CIE 1931 XY chromaticity diagram is a projection of the three dimensional CIE 1931 XYZ color space onto a two dimensional (x, y) space such that brightness is ignored. A technical description of the CIE 1931 XY chromaticity diagram is provided in, for example, the “Encyclopedia of Physical Science and Technology”, vol. 7, pp. 230-231 (Robert A Meyers ed., 1987); the entirety of which hereby is incorporated herein by reference. Further background information regarding the CIE 1931 XY chromaticity diagram is provided in Harbers et al., U.S. Patent Application Publication No. 2012/0224177A1 published on Sep. 6, 2012, the entirety of which hereby is incorporated herein by reference.

Throughout this specification, the term “color point” means: an (x, y) pair of chromaticity coordinates falling within the CIE 1931 XY chromaticity diagram. Color points located at or near the perimeter boundary of the CIE 1931 XY chromaticity diagram are saturated colors composed of light having a single wavelength, or having a very small spectral power distribution. Color points away from the perimeter boundary within the interior of the CIE 1931 XY chromaticity diagram are unsaturated colors that are composed of a mixture of different wavelengths.

Throughout this specification, the term “combined light emissions” means: a plurality of different light emissions that are mixed together. Throughout this specification, the term “combined color point” means: the color point, as perceived by human eyesight, of combined light emissions. Throughout this specification, a “substantially constant” combined color points are: color points of combined light emissions that are perceived by human eyesight as being uniform, i.e., as being of the same color.

Throughout this specification, the term “Planckian—black-body locus” means the curve within the CIE 1931 XY chromaticity diagram that plots the chromaticity coordinates (i.e., color points) that obey Planck's equation: E(λ)=Aλ−5/(eB/T−1), where E is the emission intensity, X is the emission wavelength, T is the color temperature in degrees Kelvin of a black-body radiator, and A and B are constants. The Planckian—black-body locus corresponds to the locations of color points of light emitted by a black-body radiator that is heated to various temperatures. As a black-body radiator is gradually heated, it becomes an incandescent light emitter (being referred to throughout this specification as an “incandescent light emitter”) and first emits reddish light, then yellowish light, and finally bluish light with increasing temperatures. This incandescent glowing occurs because the wavelength associated with the peak radiation of the black-body radiator becomes progressively shorter with gradually increasing temperatures, consistent with the Wien Displacement Law. The CIE 1931 XY chromaticity diagram further includes a series of lines each having a designated corresponding temperature listing in units of degrees Kelvin spaced apart along the Planckian—black-body locus and corresponding to the color points of the incandescent light emitted by a black-body radiator having the designated temperatures. Throughout this specification, such a temperature listing is referred to as a “correlated color temperature” (herein also referred to as the “CCT”) of the corresponding color point. Correlated color temperatures are expressed herein in units of degrees Kelvin (K). Throughout this specification, each of the lines having a designated temperature listing is referred to as an “isotherm” of the corresponding correlated color temperature.

Throughout this specification, the term “chromaticity bin” means: a bounded region within the CIE 1931 XY chromaticity diagram. As an example, a chromaticity bin may be defined by a series of chromaticity (x,y) coordinates, being connected in series by lines that together form the bounded region. As another example, a chromaticity bin may be defined by several lines or other boundaries that together form the bounded region, such as: one or more isotherms of CCT's; and one or more portions of the perimeter boundary of the CIE 1931 chromaticity diagram.

Throughout this specification, the term “delta(uv)” means: the shortest distance of a given color point away from (i.e., above or below) the Planckian—black-body locus. In general, color points located at a delta(uv) of about equal to or less than 0.015 may be assigned a correlated color temperature (CCT).

Throughout this specification, the term “greenish-blue light” means: light having a perceived color point being within a range of between about 490 nanometers and about 482 nanometers (herein referred to as a “greenish-blue color point.”).

Throughout this specification, the term “blue light” means: light having a perceived color point being within a range of between about 482 nanometers and about 470 nanometers (herein referred to as a “blue color point.”).

Throughout this specification, the term “purplish-blue light” means: light having a perceived color point being within a range of between about 470 nanometers and about 380 nanometers (herein referred to as a “purplish-blue color point.”).

Throughout this specification, the term “reddish-orange light” means: light having a perceived color point being within a range of between about 610 nanometers and about 620 nanometers (herein referred to as a “reddish-orange color point.”).

Throughout this specification, the term “red light” means: light having a perceived color point being within a range of between about 620 nanometers and about 640 nanometers (herein referred to as a “red color point.”).

Throughout this specification, the term “deep red light” means: light having a perceived color point being within a range of between about 640 nanometers and about 670 nanometers (herein referred to as a “deep red color point.”).

Throughout this specification, the term “visible light” means light having one or more wavelengths being within a range of between about 380 nanometers and about 670 nanometers; and “visible light spectrum” means the range of wavelengths of between about 380 nanometers and about 670 nanometers.

Throughout this specification, the term “white light” means: light having a color point located at a delta(uv) of about equal to or less than 0.006 and having a CCT being within a range of between about 10000K and about 1800K (herein referred to as a “white color point.”). Many different hues of light may be perceived as being “white.” For example, some “white” light, such as light generated by a tungsten filament incandescent lighting device, may appear yellowish in color, while other “white” light, such as light generated by some fluorescent lighting devices, may appear more bluish in color. As examples, white light having a CCT of about 3000K may appear yellowish in color, while white light having a CCT of about equal to or greater than 8000K may appear more bluish in color and may be referred to as “cool” white light. Further, white light having a CCT of between about 2500K and about 4500K may appear reddish or yellowish in color and may be referred to as “warm” white light. “White light” includes light having a spectral power distribution of wavelengths including red, green and blue color points. In an example, a CCT of a lumiphor may be tuned by selecting one or more particular luminescent materials to be included in the lumiphor. For example, light emissions from a semiconductor light-emitting device that includes three separate emitters respectively having red, green and blue color points with an appropriate spectral power distribution may have a white color point. As another example, light perceived as being “white” may be produced by mixing light emissions from a semiconductor light-emitting device having a blue, greenish-blue or purplish-blue color point together with light emissions having a yellow color point being produced by passing some of the light emissions having the blue, greenish-blue or purplish-blue color point through a lumiphor to down-convert them into light emissions having the yellow color point. General background information on systems and processes for generating light perceived as being “white” is provided in “Class A Color Designation for Light Sources Used in General Illumination”, Freyssinier and Rea, J. Light & Vis. Env., Vol. 37, No. 2 & 3 (Nov. 7, 2013, Illuminating Engineering Institute of Japan), pp. 10-14; the entirety of which hereby is incorporated herein by reference.

Throughout this specification, the term “color rendition index” (herein also referred to as “CRT-Ra”) means: the quantitative measure on a scale of 1-100 of the capability of a given light source to accurately reveal the colors of one or more objects having designated reference colors, in comparison with the capability of a black-body radiator to accurately reveal such colors. The CRI-Ra of a given light source is a modified average of the relative measurements of color renditions by that light source, as compared with color renditions by a reference black-body radiator, when illuminating objects having the designated reference color(s). The CRT is a relative measure of the shift in perceived surface color of an object when illuminated by a particular light source versus a reference black-body radiator. The CRI-Ra will equal 100 if the color coordinates of a set of test colors being illuminated by the given light source are the same as the color coordinates of the same set of test colors being irradiated by the black-body radiator. The CRT system is administered by the International Commission on Illumination (CIE). The CIE selected fifteen test color samples (respectively designated as R₁₋₁₅) to grade the color properties of a white light source. The first eight test color samples (respectively designated as R₁₋₈) are relatively low saturated colors and are evenly distributed over the complete range of hues. These eight samples are employed to calculate the general color rendering index Ra. The general color rendering index Ra is simply calculated as the average of the first eight color rendering index values, R₁₋₈. An additional seven samples (respectively designated as R₉₋₁₅) provide supplementary information about the color rendering properties of a light source; the first four of them focus on high saturation, and the last three of them are representative of well-known objects. A set of color rendering index values, R₁₋₁₅, can be calculated for a particular correlated color temperature (CCT) by comparing the spectral response of a light source against that of each test color sample, respectively. As another example, the CRI-Ra may consist of one test color, such as the designated red color of R₉.

As examples, sunlight generally has a CRI-Ra of about 100; incandescent light bulbs generally have a CRI-Ra of about 95; fluorescent lights generally have a CRI-Ra of about 70 to 85; and monochromatic light sources generally have a CRI-Ra of about zero. As an example, a light source for general illumination applications where accurate rendition of object colors may not be considered important may generally need to have a CRI-Ra value being within a range of between about 70 and about 80. Further, for example, a light source for general interior illumination applications may generally need to have a CRI-Ra value being at least about 80. As an additional example, a light source for general illumination applications where objects illuminated by the lighting device may be considered to need to appear to have natural coloring to the human eye may generally need to have a CRI-Ra value being at least about 85. Further, for example, a light source for general illumination applications where good rendition of perceived object colors may be considered important may generally need to have a CRI-Ra value being at least about 90.

Throughout this specification, the term “in contact with” means: that a first object, being “in contact with” a second object, is in either direct or indirect contact with the second object. Throughout this specification, the term “in indirect contact with” means: that the first object is not in direct contact with the second object, but instead that there are a plurality of objects (including the first and second objects), and each of the plurality of objects is in direct contact with at least one other of the plurality of objects (e.g., the first and second objects are in a stack and are separated by one or more intervening layers). Throughout this specification, the term “in direct contact with” means: that the first object, which is “in direct contact” with a second object, is touching the second object and there are no intervening objects between at least portions of both the first and second objects.

Throughout this specification, the term “spectrophotometer” means: an apparatus that can measure a light beam's intensity as a function of its wavelength and calculate its total luminous flux.

Throughout this specification, the term “integrating sphere-spectrophotometer” means: a spectrophotometer operationally connected with an integrating sphere. An integrating sphere (also known as an Ulbricht sphere) is an optical component having a hollow spherical cavity with its interior covered with a diffuse white reflective coating, with small holes for entrance and exit ports. Its relevant property is a uniform scattering or diffusing effect. Light rays incident on any point on the inner surface are, by multiple scattering reflections, distributed equally to all other points. The effects of the original direction of light are minimized. An integrating sphere may be thought of as a diffuser which preserves power but destroys spatial information. Another type of integrating sphere that can be utilized is referred to as a focusing or Coblentz sphere. A Coblentz sphere has a mirror-like (specular) inner surface rather than a diffuse inner surface. Light scattered by the interior of an integrating sphere is evenly distributed over all angles. The total power (radiant flux) of a light source can then be measured without inaccuracy caused by the directional characteristics of the source. Background information on integrating sphere-spectrophotometer apparatus is provided in Liu et al., U.S. Pat. No. 7,532,324 issued on May 12, 2009, the entirety of which hereby is incorporated herein by reference. It is understood throughout this specification that color points may be measured, for example, by utilizing a spectrophotometer, such as an integrating sphere-spectrophotometer. The spectra of reflectance values, absorbance values, and transmittance values of a reflective surface or of an object may be measured, for example, utilizing an ultraviolet-visible-near infrared (UV-VIS-NIR) spectrophotometer.

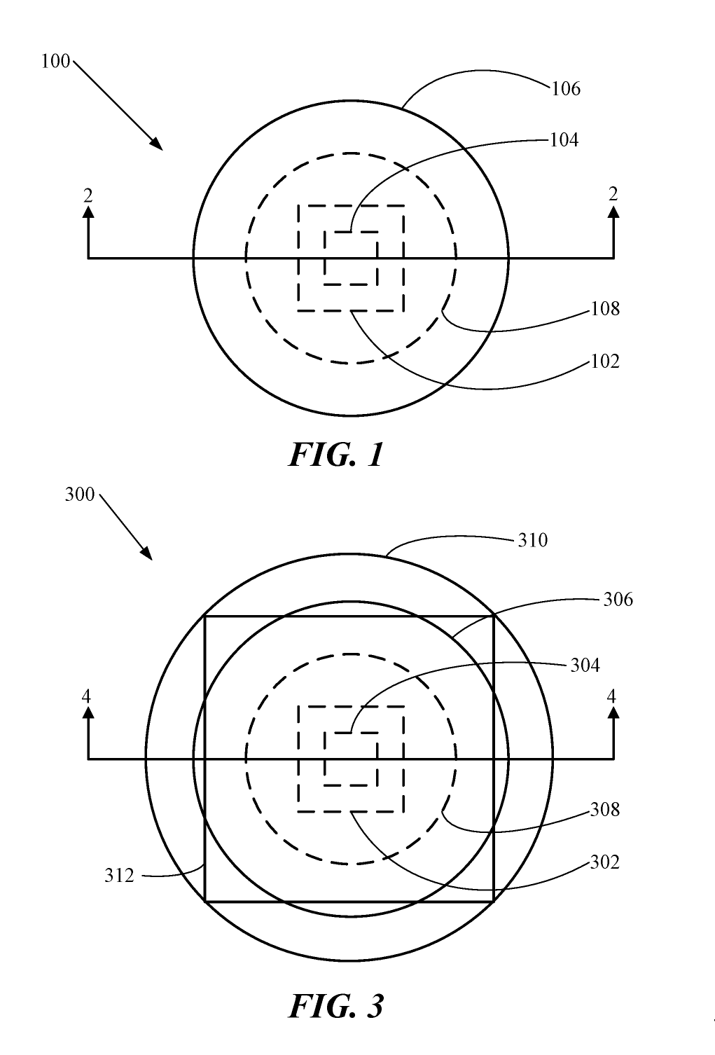

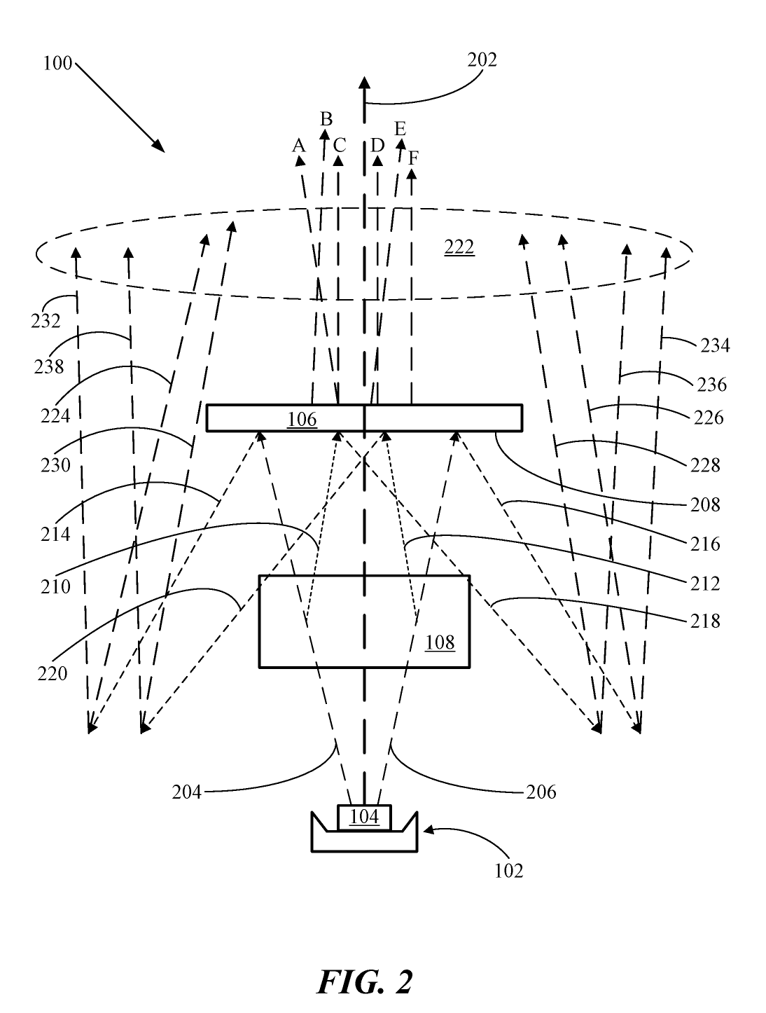

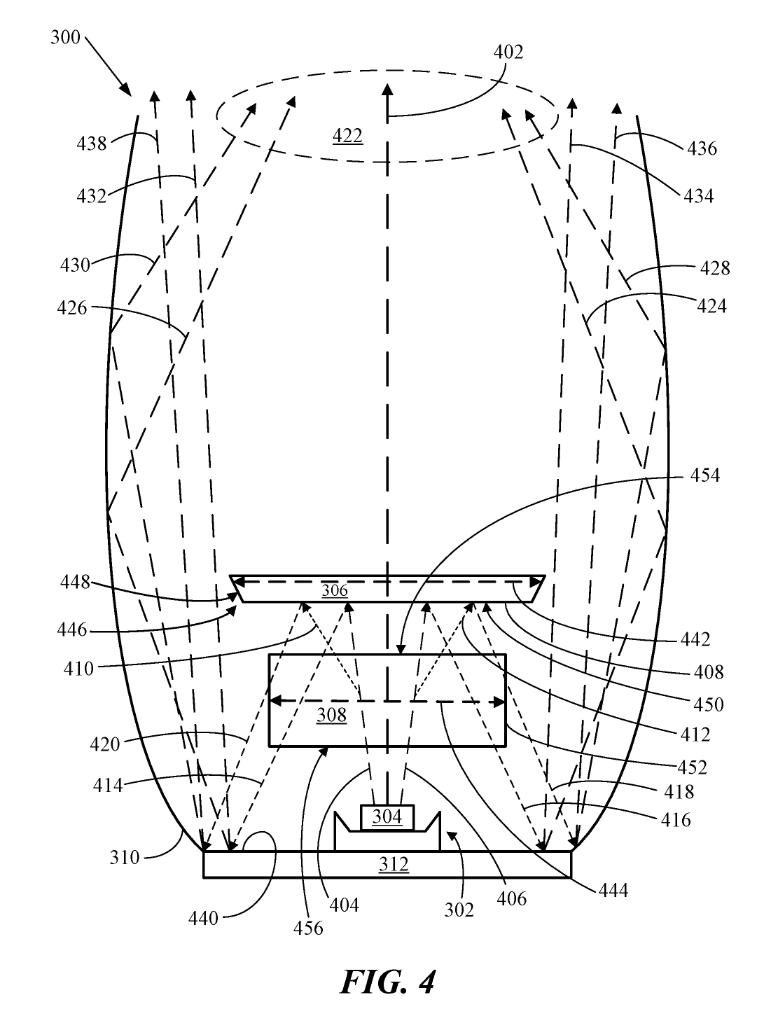

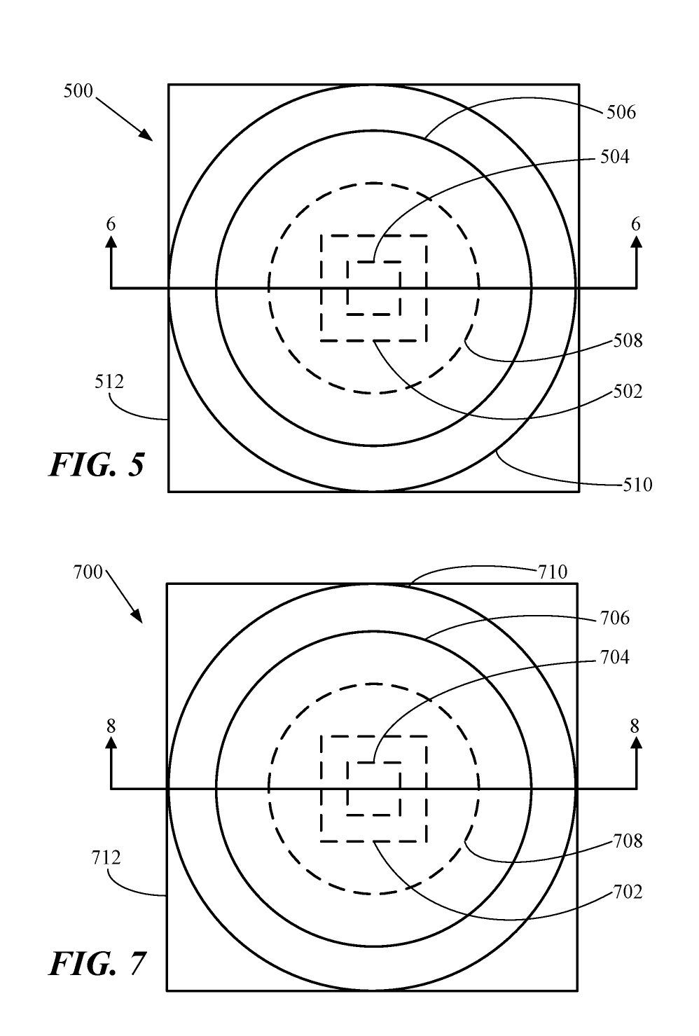

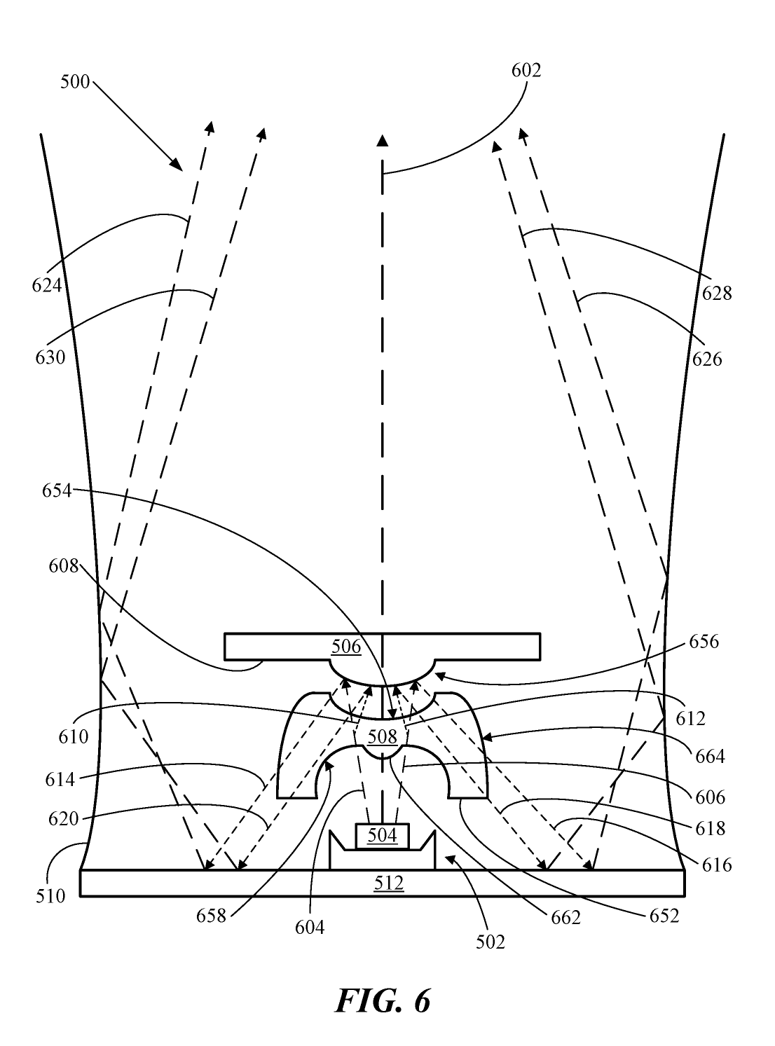

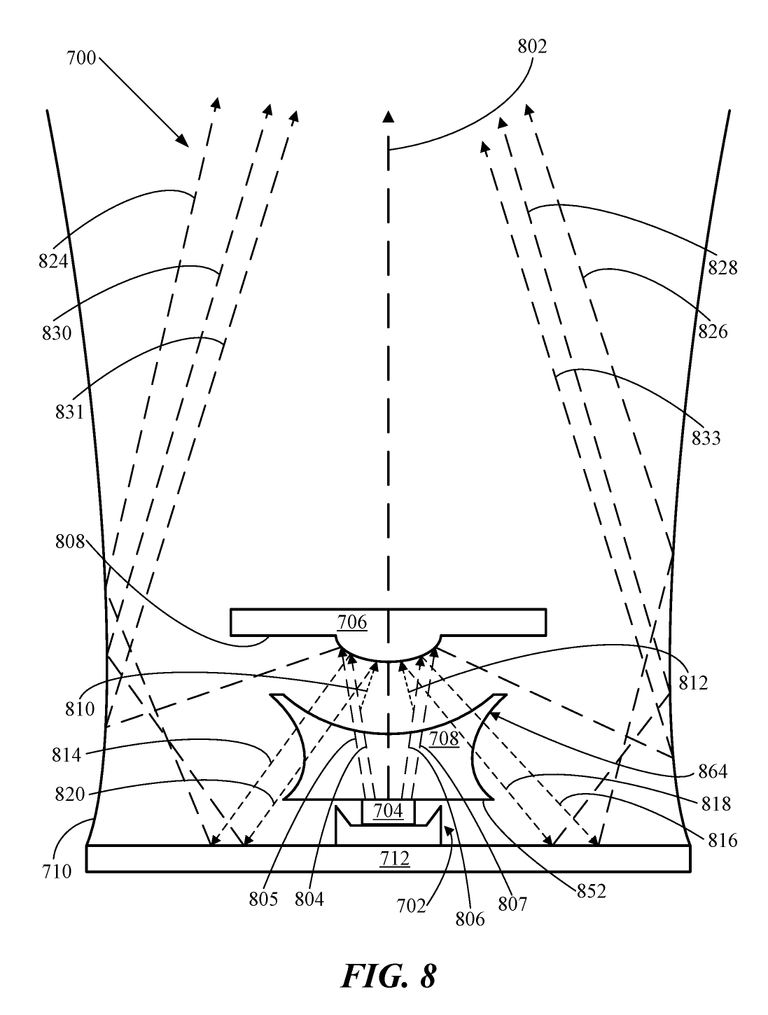

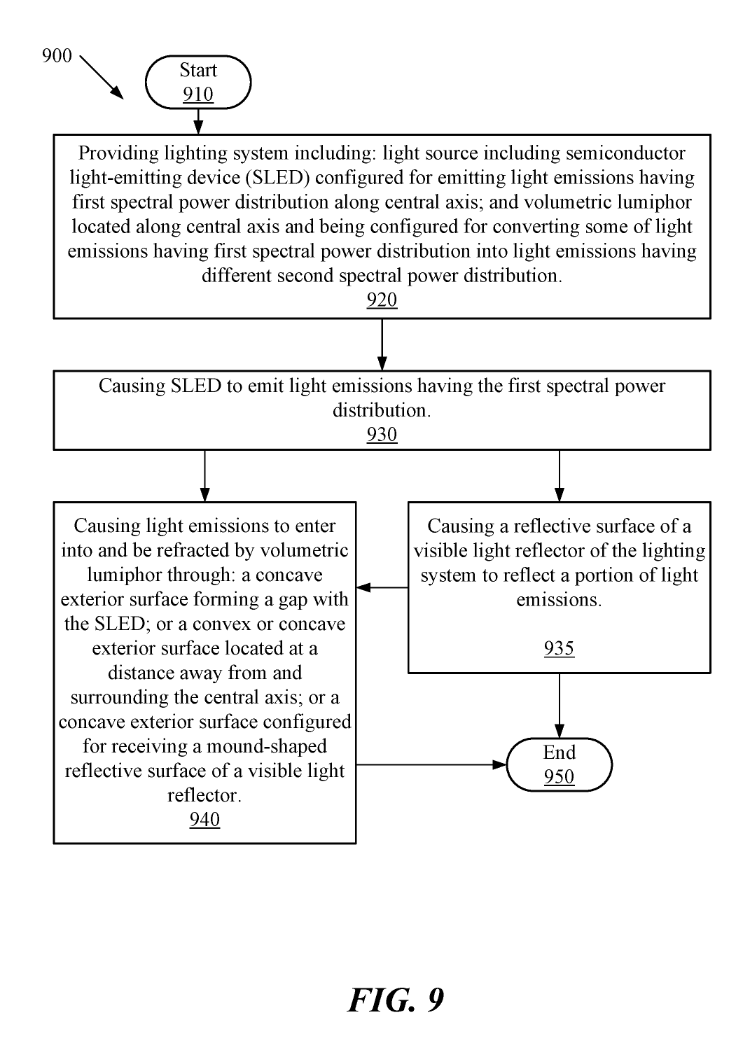

FIG. 1 is a schematic top view showing an example [100] of an implementation of a lighting system. FIG. 2 is a schematic cross-sectional view taken along the line 2-2 showing the example [100] of the lighting system. Another example [300] of an implementation of the lighting system will subsequently be discussed in connection with FIGS. 3-4. A further example of an implementation of the lighting system will subsequently be discussed in connection with FIGS. 5-6. An additional example [700] of an implementation of the lighting system will subsequently be discussed in connection with FIGS. 7-8. An example [900] of an implementation of a lighting process will be subsequently discussed in connection with FIG. 9. It is understood throughout this specification that the example [100] of an implementation of the lighting system may be modified as including any of the features or combinations of features that are disclosed in connection with: the another example [300] of an implementation of the lighting system; or the further example [500] of an implementation of the lighting system; or the additional example [700] of an implementation of the lighting system; or the example [900] of an implementation of a lighting process. Accordingly, FIGS. 3-9 and the entireties of the subsequent discussions of the examples [300], [500] and [700] of implementations of the lighting system and of the example [900] of an implementation of a lighting process are hereby incorporated into the following discussion of the example [100] of an implementation of the lighting system.

As shown in FIGS. 1 and 2, the example [100] of the implementation of the lighting system includes a light source [102] that includes a semiconductor light-emitting device [104]. As further shown in FIGS. 1 and 2, the example [100] of the lighting system includes a visible light reflector [106] and a volumetric lumiphor [108]. In another example (not shown) of the example [100] of the lighting system, the visible light reflector [106] may be omitted. In a further example (not shown) of the example [100] of the lighting system, the visible light reflector [106] may be integral with the volumetric lumiphor [108]. The semiconductor light-emitting device [104] of the example [100] of the lighting system is configured for emitting light emissions, having a first spectral power distribution, along a central axis represented by an arrow [202] and that may include, as examples, directions represented by the arrows [204], [206]. The visible light reflector [106] of the example [100] of the lighting system has a reflective surface [208] and is spaced apart along the central axis [202] at a distance away from the semiconductor light-emitting device [104]. As additionally shown in FIG. 2, the volumetric lumiphor [108] is located along the central axis [202] between the semiconductor light-emitting device [104] and the visible light reflector [106]. The volumetric lumiphor [108] may be, as shown in FIG. 2, remotely-located at a distance away from the semiconductor light-emitting device [104]. In another example (not shown), the volumetric lumiphor [108] may be in direct contact along the central axis [202] with the semiconductor light-emitting device [104]. In the example [100] of the lighting system, the light source [102] and the semiconductor light-emitting device [104] are shown in FIG. 1 as being objects having square shapes; and the visible light reflector [106] and the volumetric lumiphor [108] are shown in FIG. 1 as being objects having circular shapes. In other examples (not shown) of the example [100] of the lighting system, the light source [102], the semiconductor light-emitting device [104], the visible light reflector [106], and the volumetric lumiphor [108] may each independently be objects having other shapes and other relative sizes than their shapes and relative sizes as shown in FIG. 1.

The volumetric lumiphor [108] of the example [100] of the lighting system is configured for converting some of the light emissions [204], [206] of the semiconductor light-emitting device [104] having the first spectral power distribution into light emissions represented by the arrows [210], [212] having a second spectral power distribution being different than the first spectral power distribution. In the example [100] of the lighting system, the reflective surface [208] of the visible light reflector [106] is configured for causing a portion of the light emissions [204], [206] having the first spectral power distribution and a portion of the light emissions [210], [212] having the second spectral power distribution to be reflected in directions represented by the arrows [214], [216], [218], [220] by the visible light reflector [106]. The visible light reflector [106] is further configured for permitting another portion of the light emissions having the first spectral power distribution and another portion of the light emissions having the second spectral power distribution to be transmitted through the visible light reflector [106] along the central axis [202]. For example, the visible light reflector [106] may be configured for permitting the another portions of the light emissions having the first and second spectral power distributions to be transmitted through the visible light reflector [106] in the direction of the central axis [202]. Further, for example, the visible light reflector [106] may be configured for permitting the another portions of the light emissions having the first and second spectral power distributions to be transmitted through the visible light reflector [106]: in the direction of the central axis [202]; and in the examples represented by the arrows A, B, C, D, E and F of a plurality of other generally similar directions.

As an example, the reflective surface [208] of the visible light reflector [106] in the example [100] of the lighting system may be configured for causing the portions of the light emissions [214], [216], [218], [220] having the first and second spectral power distributions that are reflected by the visible light reflector [106] to have reflectance values throughout the visible light spectrum being within a range of about 0.80 and about 0.95. In another example, the visible light reflector [106] in the example [100] of the lighting system may be configured for causing the another portions of the light emissions having the first and second spectral power distributions that are transmitted through the visible light reflector [106] to have transmittance values throughout the visible light spectrum being within a range of about 0.20 and about 0.05. Further, for example, the reflective surface [208] of the visible light reflector [106] in the example [100] of the lighting system may be configured for causing some of the light emissions [214], [216], [218], [220] having the first and second spectral power distributions that are reflected by the visible light reflector [106] to be redirected in a plurality of lateral directions away from the central axis [202].

As examples, the volumetric lumiphor [108] of the example [100] of the lighting system may include: a phosphor; a quantum dot; a quantum wire; a quantum well; a photonic nanocrystal; a semiconducting nanoparticle; a scintillator; a lumiphoric ink; a lumiphoric organic dye; or a day glow tape. Further, for example, the volumetric lumiphor [108] of the example [100] of the lighting system may be configured for down-converting some of the light emissions [204], [206] of the semiconductor light-emitting device [104] having wavelengths of the first spectral power distribution into light emissions [210], [212] having wavelengths of the second spectral power distribution as being longer than wavelengths of the first spectral power distribution. As examples, the semiconductor light-emitting device [104] of the example [100] of the lighting system may be configured for emitting light having a dominant- or peak-wavelength being: within a range of between about 380 nanometers and about 530 nanometers; or being within a range of between about 420 nanometers and about 510 nanometers; or being within a range of between about 445 nanometers and about 490 nanometers. In another example, the semiconductor light-emitting device [104] of the example [100] of the lighting system may be configured for emitting light having a color point being greenish-blue, blue, or purplish-blue.

Further, for example, the semiconductor light-emitting device [104] of the example [100] of the lighting system may be configured for emitting light with the first spectral power distribution as having a dominant- or peak-wavelength being within a range of between about 445 nanometers and about 490 nanometers; and the volumetric lumiphor [108] may be configured for down-converting some of the light emissions of the semiconductor light-emitting device [104] having wavelengths of the first spectral power distribution into light emissions having wavelengths of the second spectral power distribution as having a perceived color point being within a range of between about 491 nanometers and about 575 nanometers. In that example, configuring the volumetric lumiphor [108] for down-converting some of the light emissions of the semiconductor light-emitting device [104] into light emissions having wavelengths of the second spectral power distribution may include providing the volumetric lumiphor [108] as including a first lumiphor that generates light emissions having a perceived color point being within the range of between about 491 nanometers and about 575 nanometers, wherein the first lumiphor includes: a phosphor; a quantum dot; a quantum wire; a quantum well; a photonic nanocrystal; a semiconducting nanoparticle; a scintillator; a lumiphoric ink; a lumiphoric organic dye; or a day glow tape.

In another example, the semiconductor light-emitting device [104] of the example [100] of the lighting system may be configured for emitting light with the first spectral power distribution as having a dominant- or peak-wavelength being within a range of between about 445 nanometers and about 490 nanometers; and the volumetric lumiphor [108] may be configured for down-converting some of the light emissions of the semiconductor light-emitting device [104] having wavelengths of the first spectral power distribution into light emissions having wavelengths of a third spectral power distribution having a perceived color point being within a range of between about 610 nanometers and about 670 nanometers. In that example, configuring the volumetric lumiphor [108] for down-converting some of the light emissions of the semiconductor light-emitting device [104] into light emissions having wavelengths of the third spectral power distribution may also include providing the volumetric lumiphor [108] as including a second lumiphor that generates light emissions having a perceived color point being within the range of between about 610 nanometers and about 670 nanometers, wherein the second lumiphor includes: a phosphor; a quantum dot; a quantum wire; a quantum well; a photonic nanocrystal; a semiconducting nanoparticle; a scintillator; a lumiphoric ink; a lumiphoric organic dye; or a day glow tape.

In an additional example, the volumetric lumiphor [108] of the example [100] of the lighting system may include: a first lumiphor that generates light emissions having a second spectral power distribution with a perceived color point being within the range of between about 491 nanometers and about 575 nanometers; and a second lumiphor that generates light emissions having a third spectral power distribution with a perceived color point being within the range of between about 610 nanometers and about 670 nanometers. Further in that additional example, the semiconductor light-emitting device [104] of the example [100] of the lighting system may be configured for emitting light with the first spectral power distribution as having a dominant- or peak-wavelength being within a range of between about 445 nanometers and about 490 nanometers. As a further example of the example [100] of the lighting system, the first lumiphor may include a first quantum material, and the second lumiphor may include a different second quantum material, and the first and second quantum materials may both have spectral power distributions for light absorption being separate from the second and third spectral power distributions of their respective light emissions. In this further example, cross-absorption of light emissions among the two different quantum materials of the lumiphor [108] may be minimized, which may result in an increased luminous flux, and an increased CRI-Ra, of the light emissions of the example [100] of the lighting system. Further, for example, the example [100] of the lighting system may include three, four, or five, or more different quantum materials each having a spectral power distribution for light absorption being separate from the second and third spectral power distributions and from any further spectral power distributions of the light emissions of the quantum materials. In additional examples, the example [100] of the lighting system may be configured for generating light emissions having a selected total luminous flux, such as, for example, 500 lumens, or 1,500 lumens, or 5,000 lumens. As examples, configuring the example [100] of the lighting system for generating light emissions having such a selected total luminous flux may include: selecting particular luminescent materials for or varying the concentrations of one or more luminescent materials or light-scattering particles in the volumetric lumiphor [108]; and varying a total luminous flux of the light emissions from the semiconductor light-emitting device [104].

As another example, the example [100] of the lighting system may be configured for forming combined light emissions [222] by causing some or most of the light emissions [214], [216] having the first spectral power distribution to be redirected in a plurality of directions represented by the arrows [224], [226] intersecting the central axis [202] and combined together with some or most of the light emissions [218], [220] having the second spectral power distribution being redirected in a plurality of directions represented by the arrows [228], [230] intersecting the central axis [202]; and the example [100] of the lighting system may be configured for causing some or most of the combined light emissions [222] to be emitted from the example [100] of the lighting system in the plurality of directions [224], [226], [228], [230] intersecting the central axis [202]. As a further example, the example [100] of the lighting system may be configured for forming combined light emissions [222] by causing some or most of the light emissions [214], [216] having the first spectral power distribution to be redirected in a plurality of directions represented by the arrows [232], [234] diverging away from the central axis [202] and causing some or most of the light emissions [218], [220] having the second spectral power distribution to be redirected in a plurality of directions represented by the arrows [236], [238] diverging away from the central axis [202]; and the example [100] of the lighting system may be configured for causing some or most of the combined light emissions [222] to be emitted from the example [100] of the lighting system in the plurality of directions [232], [234], [236], [238] diverging away from the central axis [202].

Further, for example, the example [100] of the lighting system may be configured for causing the light emissions having the first and second spectral power distributions to be combined together forming combined light emissions [222] having a color point with a color rendition index (CRI-Ra including R₁₋₈ or including R₁₋₁₅) being: about equal to or greater than 50; or about equal to or greater than 75; or about equal to or greater than 95. Additionally, for example, the example [100] of the lighting system may be configured for causing the light emissions having the first and second spectral power distributions to be combined together forming combined light emissions [222] having a color point with a color rendition index (CRI-R₉) being: about equal to or greater than 50; or about equal to or greater than 75; or about equal to or greater than 90. In another example, the example [100] of the lighting system may be configured for causing light emissions having first, second and third spectral power distributions to be combined together forming combined light emissions [222] having a color point with a color rendition index (CRI-Ra including R₁₋₈ or including R₁₋₁₅) being: about equal to or greater than 50; or about equal to or greater than 75; or about equal to or greater than 95. In other examples, the example [100] of the lighting system may be configured for causing light emissions having first, second and third spectral power distributions to be combined together forming combined light emissions [222] having a color point with a color rendition index (CRI-R₉) being: about equal to or greater than 50; or about equal to or greater than 75; or about equal to or greater than 90.

In another example, the example [100] of the lighting system may be configured for causing some or most of the light emissions having the first and second spectral power distributions, or configured for causing some or most of the light emissions having first, second and third spectral power distributions, to be combined together to form combined light emissions [222] having a color point being: within a distance of about equal to or less than about +/−0.009 delta(uv) away from the Planckian—black-body locus throughout a spectrum of correlated color temperatures (CCTs) within a range of between about 1800K and about 6500K or within a range of between about 2400K and about 4000K; or below the Planckian—black-body locus by a distance of about equal to or less than about 0.009 delta(uv) throughout a spectrum of correlated color temperatures (CCTs) within a range of between about 1800K and about 6500K or within a range of between about 2400K and about 4000K. As an example, configuring the example [100] of the lighting system for causing some or most of the light emissions to be so combined together to form combined light emissions [222] having such a color point may include providing the volumetric lumiphor [108] being, as shown in FIG. 2, remotely-located at a distance away from the semiconductor light-emitting device [104].

FIG. 3 is a schematic top view showing another example [300] of an implementation of a lighting system. FIG. 4 is a schematic cross-sectional view taken along the line 4-4 showing the another example [300] of the lighting system. Another example [100] of an implementation of the lighting system was earlier discussed in connection with FIGS. 1-2. A further example [500] of an implementation of the lighting system will subsequently be discussed in connection with FIGS. 5-6. An additional example [700] of an implementation of the lighting system will subsequently be discussed in connection with FIGS. 7-8. An example [900] of an implementation of a lighting process will be subsequently discussed in connection with FIG. 9. It is understood throughout this specification that the example [300] of an implementation of the lighting system may be modified as including any of the features or combinations of features that are disclosed in connection with: the another example [100] of an implementation of the lighting system; or the further example [500] of an implementation of the lighting system; or the additional example [700] of an implementation of the lighting system; or the example [900] of an implementation of a lighting process. Accordingly, FIGS. 1-2 and 5-9 and the entireties of the earlier discussion of the examples [100] of implementations of the lighting system and the subsequent discussions of the examples [500] and [700] of implementations of the lighting system and of the example [900] of an implementation of a lighting process are hereby incorporated into the following discussion of the example [300] of an implementation of the lighting system.

As shown in FIGS. 3 and 4, the example [300] of the implementation of the lighting system includes a light source [302] that includes a semiconductor light-emitting device [304]. As further shown in FIGS. 3 and 4, the example [300] of the lighting system includes a visible light reflector [306], a volumetric lumiphor [308], and a primary visible light reflector [310]. In another example (not shown) of the example [300] of the lighting system, the visible light reflector [306] may be omitted. Further for example, as shown in FIGS. 3-4, the primary visible light reflector [310] may include a truncated parabolic reflector. The semiconductor light-emitting device [304] of the example [300] of the lighting system is configured for emitting light emissions having a first spectral power distribution along a central axis represented by an arrow [402], and that may include, as examples, directions represented by the arrows [404], [406]. The visible light reflector [306] of the example [300] of the lighting system has a reflective surface [408] and is spaced apart along the central axis [402] at a distance away from the semiconductor light-emitting device [304]. As additionally shown in FIG. 4, the volumetric lumiphor [308] is located along the central axis [402] between the semiconductor light-emitting device [304] and the visible light reflector [306]. The volumetric lumiphor [308] may be, as shown in FIG. 4, remotely-located at a distance away from the semiconductor light-emitting device [304]. In another example (not shown), the volumetric lumiphor [308] may be in direct contact along the central axis [402] with the semiconductor light-emitting device [304]. Further, the volumetric lumiphor [308] of the example [300] of the lighting system is configured for converting some of the light emissions [404], [406] of the semiconductor light-emitting device [304] having the first spectral power distribution into light emissions represented by the arrows [410], [412] having a second spectral power distribution being different than the first spectral power distribution. In the example [300] of the lighting system, the reflective surface [408] of the visible light reflector [306] is configured for causing a portion of the light emissions [404], [406] having the first spectral power distribution and a portion of the light emissions [410], [412] having the second spectral power distribution to be reflected in directions represented by the arrows [414], [416], [418], [420] by the visible light reflector [306]. The visible light reflector [306] may be, as examples, further configured for permitting another portion of the light emissions having the first spectral power distribution and another portion of the light emissions having the second spectral power distribution to be transmitted through the visible light reflector [306] along the central axis [402].

In this example [300] of the lighting system, the reflective surface [408] of the visible light reflector [306] may be configured for causing some of the light emissions having the first and second spectral power distributions that are reflected by the visible light reflector [306] to be redirected in a plurality of lateral directions [414], [416], [418], [420] away from the central axis [402]. As another example, the primary visible light reflector [310] may be configured for causing some or most of the light emissions to be redirected from the lateral directions [414], [416], [418], [420] in a plurality of directions represented by the arrows [424], [426], [428], [430] intersecting the central axis [402]. In a further example of the example [300] of the lighting system, the semiconductor light-emitting device [304] may be configured for emitting the light emissions of the first spectral power distribution as having a luminous flux of a first magnitude, and the example [300] of the lighting system may be configured for causing the some or most of the light emissions that are redirected in the plurality of directions [424], [426], [428], [430] intersecting the central axis [402] to have a luminous flux of a second magnitude being: at least about 50% as great as the first magnitude; or at least about 80% as great as the first magnitude.

As another example, the example [300] of the lighting system may be configured for forming combined light emissions [422] by causing some or most of the light emissions [414], [416] having the first spectral power distribution to be combined together with some or most of the light emissions [418], [420] having the second spectral power distribution; and the example [300] of the lighting system may be configured for causing some or most of the combined light emissions [422] to be emitted from the example [300] of the lighting system in a plurality of directions [424], [426], [428], [430] intersecting the central axis [402]. In an additional example, the example [300] of the lighting system may be configured for forming combined light emissions [422] by causing some or most of the light emissions [414], [416] having the first spectral power distribution to be combined together with some or most of the light emissions [418], [420] having the second spectral power distribution; and the example [300] of the lighting system may be configured for causing some or most of the combined light emissions to be emitted from the example [300] of the lighting system in a plurality of directions represented by the arrows [432], [434], [436], [438] diverging away from the central axis [402]. Further, for example, the example [300] of the lighting system may be configured for causing the light emissions having the first and second spectral power distributions to be combined together forming combined light emissions [422] having a color point with a color rendition index (CRI-Ra including R₁₋₈ or including R₁₋₁₅) being: about equal to or greater than 50; or about equal to or greater than 75; or about equal to or greater than 95. Additionally, for example, the example [300] of the lighting system may be configured for causing the light emissions having the first and second spectral power distributions to be combined together forming combined light emissions [422] having a color point with a color rendition index (CRI-R₉) being: about equal to or greater than 50; or about equal to or greater than 75; or about equal to or greater than 90.

The example [300] of the lighting system may, for example, include another visible light reflector [312]. As an example, the semiconductor light-emitting device [304] in the example [300] of the lighting system may be located along the central axis [402] between the another visible light reflector [312] and the volumetric lumiphor [308]. Further, for example, the another visible light reflector [312] may have another reflective surface [440] being configured for causing some of the light emissions having the first and second spectral power distributions to be reflected by the another visible light reflector [312]. As an example, the another reflective surface [440] of the another visible light reflector [312] may be configured for causing some of the light emissions [414], [416], [418], [420] that are reflected by the visible light reflector [306] to be redirected by the another visible light reflector [312] in a plurality of lateral directions [432], [434], [436], [438] away from the central axis [402]. In another example, the example [300] of the lighting system may include another semiconductor light-emitting device (not shown), being located adjacent to the semiconductor light-emitting device [304] and being located between the another visible light reflector [312] and the volumetric lumiphor [308]. In that example, the another semiconductor light-emitting device may, for example, be configured for emitting light having a dominant- or peak-wavelength being within a range of between about 380 nanometers and about 530 nanometers.

In the example [300] of the lighting system, the visible light reflector [306] may, for example, have a shape that extends away from the central axis [402] in directions being transverse to the central axis [402]. In that example, the shape of the visible light reflector [306] may, for example, be centered on the central axis [402]. Further, for example, the shape of the visible light reflector [306] may have a maximum width in the directions transverse to the central axis [402] as represented by an arrow [442]. In the example [300] of the lighting system, the volumetric lumiphor [308] may, for example, have a shape that extends away from the central axis [402] in directions being transverse to the central axis [402]. In that example, the shape of the volumetric lumiphor [308] may, for example, be centered on the central axis [402]. Further, for example, the shape of the volumetric lumiphor [308] may have a maximum width in the directions transverse to the central axis [402] as represented by an arrow [444]. In the example [300] of the lighting system as shown in FIGS. 3-4, the maximum width of the volumetric lumiphor [308] in the directions transverse to the central axis [402] represented by the arrow [444] may be smaller than the maximum width of the visible light reflector [306] in the directions transverse to the central axis [402] represented by the arrow [442]. In another example [300] of the lighting system (not shown), the maximum width of the volumetric lumiphor [308] in the directions transverse to the central axis [402] represented by the arrow [444] may be equal to or larger than the maximum width of the visible light reflector [306] in the directions transverse to the central axis [402] represented by the arrow [442].

Additionally, for example, a distal portion [446] of the reflective surface [408] of the visible light reflector [306] that is located at a greatest distance away from the central axis [402] may have a beveled edge [448]. As an example, the beveled edge [448] of the visible light reflector [306] may facilitate configuring the example [300] of the lighting system for causing most of the light emissions [414], [416], [418], [420] that are reflected by the reflective surface [408] of the visible light reflector [306] to be redirected by the primary visible light reflector [310] from the lateral directions [414], [416], [418], [420] in the plurality of directions [424], [426], [428], [430] intersecting the central axis [402].

As another example, a portion [450] of the reflective surface [408] of the visible light reflector [306] in the example [300] of the lighting system may be a planar reflective surface. Further, for example, the portion [450] of the reflective surface [408] of the visible light reflector [306] in the example [300] of the lighting system may face toward the semiconductor light-emitting device [304] and may extend away from the central axis [402] in directions being transverse to the central axis [402]. In the example [300] of the lighting system, the portion [450] of the reflective surface [408] of the visible light reflector [306] may for example, face toward the semiconductor light-emitting device [304]; and the volumetric lumiphor [308] may have an exterior surface [452], wherein a portion [454] of the exterior surface [452] may face toward the portion [450] of the reflective surface [408] of the visible light reflector [306]. Further, for example, the portion [454] of the exterior surface [452] of the volumetric lumiphor [308] may be configured for permitting entry into the volumetric lumiphor [308] by light emissions having the first and second spectral power distributions, including for example some of the light emissions [414], [416], [418], [420] reflected by the visible light reflector [306]. Additionally, for example, a portion [456] of the exterior surface [452] of the volumetric lumiphor [308] may face toward the semiconductor light-emitting device [304]. Further in that example, the portion [456] of the exterior surface [452] may cause some of the light emissions [404], [406] being emitted from the semiconductor light-emitting device [304] to be reflected in lateral directions towards the another visible light reflector [312].

FIG. 5 is a schematic top view showing a further example [500] of an implementation of a lighting system. FIG. 6 is a schematic cross-sectional view taken along the line 6-6 showing the further example [500] of the lighting system. Another example [100] of an implementation of the lighting system was earlier discussed in connection with FIGS. 1-2. A further example [300] of an implementation of the lighting system was earlier discussed in connection with FIGS. 3-4. An additional example [700] of an implementation of the lighting system will subsequently be discussed in connection with FIGS. 7-8. An example [900] of an implementation of a lighting process will be subsequently discussed in connection with FIG. 9. It is understood throughout this specification that the example [500] of an implementation of the lighting system may be modified as including any of the features or combinations of features that are disclosed in connection with: the another example [100] of an implementation of the lighting system; or the further example [300] of an implementation of the lighting system; or the additional example [700] of an implementation of the lighting system; or the example [900] of an implementation of a lighting process. Accordingly, FIGS. 1-4 and 7-9 and the entireties of the earlier discussion of the examples [100] and [300] of implementations of the lighting system and the subsequent discussion of the examples [700] of implementations of the lighting system and of the example [900] of an implementation of a lighting process are hereby incorporated into the following discussion of the example [500] of an implementation of the lighting system.

As shown in FIGS. 5 and 6, the example [500] of the implementation of the lighting system includes a light source [502] that includes a semiconductor light-emitting device [504]. As further shown in FIGS. 5 and 6, the example [500] of the lighting system includes a visible light reflector [506], a volumetric lumiphor [508], and a primary visible light reflector [510]. In another example (not shown) of the example [500] of the lighting system, the visible light reflector [506] may be omitted. Further for example, as shown in FIGS. 5-6, the primary visible light reflector [510] may include a truncated conical reflector. The semiconductor light-emitting device [504] of the example [500] of the lighting system is configured for emitting light emissions, having a first spectral power distribution, along a central axis represented by an arrow [602], and that may include, as examples, directions represented by the arrows [604], [606]. The visible light reflector [506] of the example [500] of the lighting system has a reflective surface [608] and is spaced apart along the central axis [602] at a distance away from the semiconductor light-emitting device [504]. As additionally shown in FIG. 6, the volumetric lumiphor [508] is located along the central axis [602] between the semiconductor light-emitting device [504] and the visible light reflector [506]. The volumetric lumiphor [508] may be, as shown in FIG. 6, remotely-located at a distance away from the semiconductor light-emitting device [504]. In another example (not shown), the volumetric lumiphor [508] may be in direct contact along the central axis [602] with the semiconductor light-emitting device [504]. The example [500] of the lighting system may, for example, include another visible light reflector [512]. Further, the volumetric lumiphor [508] of the example [500] of the lighting system is configured for converting some of the light emissions [604], [606] of the semiconductor light-emitting device [504] having the first spectral power distribution into light emissions represented by the arrows [610], [612] having a second spectral power distribution being different than the first spectral power distribution. In the example [500] of the lighting system, the reflective surface [608] of the visible light reflector [506] is configured for causing a portion of the light emissions [604], [606] having the first spectral power distribution and a portion of the light emissions [610], [612] having the second spectral power distribution to be reflected in directions represented by the arrows [614], [616], [618], [620] by the visible light reflector [506]. The visible light reflector [506] may be, as examples, further configured for permitting another portion of the light emissions having the first spectral power distribution and another portion of the light emissions having the second spectral power distribution to be transmitted through the visible light reflector [506] along the central axis [602].

In this example [500] of the lighting system, the reflective surface [608] of the visible light reflector [506] may be configured for causing some of the light emissions having the first and second spectral power distributions that are reflected by the visible light reflector [506] to be redirected in a plurality of lateral directions [614], [616], [618], [620] away from the central axis [602]. As another example, the primary visible light reflector [510] may be configured for causing some or most of the light emissions having the first and second spectral power distributions, including for example some or most of the light emissions that are redirected in the lateral directions [614], [616], [618], [620], to be redirected in a plurality of directions represented by the arrows [624], [626], [628], [630] intersecting the central axis [602]. In a further example of the example [500] of the lighting system, the semiconductor light-emitting device [504] may be configured for emitting the light emissions of the first spectral power distribution as having a luminous flux of a first magnitude, and the example [500] of the lighting system may be configured for causing the some or most of the light emissions that are redirected in the plurality of directions [624], [626], [628], [630] intersecting the central axis [602] to have a luminous flux of a second magnitude being: at least about 50% as great as the first magnitude; or at least about 80% as great as the first magnitude. In an additional example, the example [500] of the lighting system may be configured for causing some or most of the light emissions [614], [616] having the first spectral power distribution and some or most of the light emissions [618], [620] having the second spectral power distribution to be emitted from the example [500] of the lighting system in a plurality of directions diverging away from the central axis [602].

In an example, a portion [656] of the reflective surface [608] of the visible light reflector [506] may be a mound-shaped reflective surface [656] facing toward the semiconductor light-emitting device [504]. In that example, a shortest distance between the semiconductor light-emitting device [504] and the portion [656] of the reflective surface [608] of the visible light reflector [506] may, as an example, be located along the central axis [602]. For example, the mound-shaped reflective surface [656] of the visible light reflector [506] may be configured for causing some of the light emissions [604], [606], [610], [612] that are reflected by the reflective surface [608] to be redirected in a plurality of lateral directions [614], [616], [618], [620] away from the central axis [602].

As another example, the portion [656] of the reflective surface [608] of the visible light reflector [506] in the example [500] of the lighting system may be a mound-shaped reflective surface [656] facing toward the semiconductor light-emitting device [504]. As an additional example, the mound-shaped reflective surface [656] of the visible light reflector [506] may be configured for causing some of the light emissions [604], [606], [610], [612] that are reflected by the reflective surface [608] to be redirected in a plurality of lateral directions [614], [616], [618], [620] away from the central axis [602]. Further, for example, the volumetric lumiphor [508] may have an exterior surface [652], wherein a portion [654] of the exterior surface [652] is a concave exterior surface [654] being configured for receiving the mound-shaped reflective surface [656] of the visible light reflector [506]. In that example [500], the lighting system may be configured for causing some of the light emissions having the first and second spectral power distributions to be emitted as represented by the arrows [604], [606], [610], [612] through the concave exterior surface [654] of the volumetric lumiphor [508]; and the reflective surface [656] of the visible light reflector [506] may be configured for causing some of the light emissions having the first and second spectral power distributions to be reflected by the reflective surface [608] and to enter into the volumetric lumiphor [508] through the concave exterior surface [654]. In an example, the concave exterior surface [654] of the volumetric lumiphor [508] may be spaced apart along the central axis [602] from the mound-shaped reflective surface [656] of the visible light reflector [506]. In another example (not shown), the concave exterior surface [654] of the volumetric lumiphor [508] may receive and be in direct contact with the mound-shaped reflective surface [656] of the visible light reflector [506].

In another example, the volumetric lumiphor [508] of the example [500] of the lighting system may have the exterior surface [652], wherein a portion [658] of the exterior surface [652] of the volumetric lumiphor [508] is a concave exterior surface [658] forming a gap between the semiconductor light-emitting device [504] and the volumetric lumiphor [508]. In that example, the example [500] of the lighting system may be configured for causing entry of some the light emissions [604], [606] having the first spectral power distribution into the volumetric lumiphor [508] through the concave exterior surface [658]; and the volumetric lumiphor [508] may be configured for causing refraction of some of the light emissions [604], [606] having the first spectral power distribution in a plurality of lateral directions [610], [612]. Further in that example, the concave exterior surface [658] may cause some of the light emissions [604], [606] being emitted from the semiconductor light-emitting device [504] to be reflected in lateral directions towards the another visible light reflector [512].

As an additional example of the example [500] of the lighting system, the concave exterior surface [658] of the volumetric lumiphor [508] may include, and surround, a convex exterior surface [662]. Further in that example, the convex exterior surface [662] may additionally cause some of the light emissions [604], [606] being emitted from the semiconductor light-emitting device [504] to be reflected in lateral directions towards the another visible light reflector [512].

As an additional example, the volumetric lumiphor [508] of the example [500] of the lighting system may have the exterior surface [652], and a portion [664] of the exterior surface [652] may be a convex exterior surface [664] being located at a distance away from and surrounding the central axis [602]. Further in that additional example, the example [500] of the lighting system may be configured for causing some of the light emissions having the first and second spectral power distributions to enter into and be emitted from the volumetric lumiphor [508] through the convex exterior surface [664]; and the volumetric lumiphor [508] may be configured for causing refraction of some of the light emissions.

FIG. 7 is a schematic top view showing an additional example [700] of an implementation of a lighting system. FIG. 8 is a schematic cross-sectional view taken along the line 8-8 showing the additional example [700] of the lighting system. Another example [100] of an implementation of the lighting system was earlier discussed in connection with FIGS. 1-2. A further example [300] of an implementation of the lighting system was earlier discussed in connection with FIGS. 3-4. An additional example [500] of an implementation of the lighting system was earlier discussed in connection with FIGS. 5-6. An example [900] of an implementation of a lighting process will be subsequently discussed in connection with FIG. 9. It is understood throughout this specification that the example [700] of an implementation of the lighting system may be modified as including any of the features or combinations of features that are disclosed in connection with: the another example [100] of an implementation of the lighting system; or the further example [300] of an implementation of the lighting system; or the additional example [500] of an implementation of the lighting system; or the example [900] of an implementation of a lighting process. Accordingly, FIGS. 1-6 and 9 and the entireties of the earlier discussion of the examples [100], [300], [500] of implementations of the lighting system and the subsequent discussion of the example [900] of an implementation of a lighting process are hereby incorporated into the following discussion of the example [700] of an implementation of the lighting system.

As shown in FIGS. 7 and 8, the example [700] of the implementation of the lighting system includes a light source [702] that includes a semiconductor light-emitting device [704]. As further shown in FIGS. 7 and 8, the example [700] of the lighting system includes a visible light reflector [706], a volumetric lumiphor [708], and a primary total internal reflection lens [710]. In another example (not shown) of the example [700] of the lighting system, the visible light reflector [706] may be omitted. The semiconductor light-emitting device [704] of the example [700] of the lighting system is configured for emitting light emissions, having a first spectral power distribution, along a central axis represented by an arrow [802], and that may include, as examples, directions represented by the arrows [804], [806]. The visible light reflector [706] of the example [700] of the lighting system has a reflective surface [808] and is spaced apart along the central axis [802] at a distance away from the semiconductor light-emitting device [704]. As additionally shown in FIG. 8, the volumetric lumiphor [708] is located along the central axis [802] between the semiconductor light-emitting device [704] and the visible light reflector [706]. The volumetric lumiphor [708] may be, as shown in FIG. 8, in direct contact along the central axis [802] with the semiconductor light-emitting device [704]. In another example (not shown), the volumetric lumiphor [708] may be remotely-located at a distance away from the semiconductor light-emitting device [704]. The example [700] of the lighting system may, for example, include another visible light reflector [712]. Further, the volumetric lumiphor [708] of the example [700] of the lighting system is configured for converting some of the light emissions [804], [806] of the semiconductor light-emitting device [704] having the first spectral power distribution into light emissions represented by the arrows [810], [812] having a second spectral power distribution being different than the first spectral power distribution. In the example [700] of the lighting system, the reflective surface [808] of the visible light reflector [706] is configured for causing a portion of the light emissions [804], [806] having the first spectral power distribution and a portion of the light emissions [810], [812] having the second spectral power distribution to be reflected, as examples in directions represented by the arrows [814], [816], [818], [820], by the visible light reflector [706]. The visible light reflector [706] may be, as examples, further configured for permitting another portion of the light emissions having the first spectral power distribution and another portion of the light emissions having the second spectral power distribution to be transmitted through the visible light reflector [706] along the central axis [802].

In this example [700] of the lighting system, the reflective surface [808] of the visible light reflector [706] may be configured for causing some of the light emissions having the first and second spectral power distributions that are reflected by the visible light reflector [706] to be redirected in a plurality of lateral directions [814], [816], [818], [820] away from the central axis [802]. As another example, the primary total internal reflection lens [710] may be configured for causing some or most of the light emissions, examples including the light emissions redirected in the lateral directions [814], [816], [818], [820], to be redirected in a plurality of directions represented by the arrows [824], [826], [828], [830] intersecting the central axis [802]. In further examples of this example [700] of the lighting system, the reflective surface [808] of the visible light reflector [706] may be configured for causing some of the light emissions represented by the arrows [805], [807] having the first spectral power distribution that are reflected by the visible light reflector [706], and some of the light emissions (not shown) having the second spectral power distribution that are likewise reflected by the visible light reflector [706], to be redirected in a plurality of directions represented by the arrows [831], [833] laterally away from the central axis [802] and then directly reflected by the primary total internal reflection lens [710]. In a further example of the example [700] of the lighting system, the semiconductor light-emitting device [704] may be configured for emitting the light emissions of the first spectral power distribution as having a luminous flux of a first magnitude, and the example [700] of the lighting system may be configured for causing the some or most of the light emissions that are redirected in the plurality of directions [824], [826], [828], [830] intersecting the central axis [802] to have a luminous flux of a second magnitude being: at least about 50% as great as the first magnitude; or at least about 80% as great as the first magnitude. In an additional example, the example [700] of the lighting system may be configured for causing some or most of the light emissions [814], [816] having the first spectral power distribution and some or most of the light emissions [818], [820] having the second spectral power distribution to be emitted from the example [700] of the lighting system in a plurality of directions diverging away from the central axis [802].

In a further example (not shown) the primary total internal reflection lens [710] may be substituted by a light guide being configured for causing some or most of the light emissions, examples including the light emissions redirected in the lateral directions [814], [816], [818], [820], to be redirected in a plurality of other directions being different than the lateral directions.

As an additional example, the volumetric lumiphor [708] of the example [700] of the lighting system may have an exterior surface [852], and a portion [864] of the exterior surface [852] may be a concave exterior surface [864] being located at a distance away from and surrounding the central axis [802]. Further in that additional example, the example [700] of the lighting system may be configured for causing some of the light emissions having the first and second spectral power distributions to enter into and be emitted from the volumetric lumiphor [708] through the concave exterior surface [864]; and the volumetric lumiphor [708] may be configured for causing refraction of some of the light emissions.

It is understood throughout this specification that an example [100], [300], [500], [700] of a lighting system may include any combination of the features discussed in connection with the examples [100], [300], [500], [700] of a lighting system. For example, it is understood throughout this specification that an example [100], [300], [500], [700] of a lighting system may include a volumetric lumiphor [108], [308], [508], [708] that includes any combination of the features discussed in connection with the examples [100], [300], [500], [700] of a lighting system, such as: an exterior surface [452], [652], [852]; a portion [454] of the exterior surface of the volumetric lumiphor [108], [308], [508], [708] facing toward a portion of the reflective surface [208], [408], [608], [808] of the visible light reflector [106], [306], [506], [706]; a concave exterior surface [654] of the volumetric lumiphor [108], [308], [508], [708] being configured for receiving a mound-shaped reflective surface [656] of the visible light reflector [106], [306], [506], [706]; a concave exterior surface [658] of the volumetric lumiphor [108], [308], [508], [708] forming a gap between the semiconductor light-emitting device [104], [304], [504], [704] and the volumetric lumiphor [108], [308], [508], [708]; a concave exterior surface [658] further including and surrounding a convex exterior surface [662] of the volumetric lumiphor [108], [308], [508], [708]; a convex exterior surface [664] of the volumetric lumiphor [108], [308], [508], [708] being located at a distance away from and surrounding the central axis [202], [402], [602], [802]; or a concave exterior surface [864] of the volumetric lumiphor [108], [308], [508], [708] being located at a distance away from and surrounding the central axis [202], [402], [602], [802].

FIG. 9 is a flow chart showing an example [900] of an implementation of a lighting process. The example [900] of the lighting process starts at step [910]. Step [920] of the example [900] of the lighting process includes providing a lighting system [100], [300], [500], [700] including: a light source [102], [302], [502], [702] including a semiconductor light-emitting device [104], [304], [504], [704], the semiconductor light-emitting device [104], [304], [504], [704] being configured for emitting, along a central axis [202], [402], [602], [802], light emissions [204], [206], [404], [406], [604], [606], [804], [806] having a first spectral power distribution; and a volumetric lumiphor [108], [308], [508], [708], being located along the central axis [202], [402], [602], [802] and being configured for converting some of the light emissions [204], [206], [404], [406], [604], [606], [804], [806] having the first spectral power distribution into light emissions [210], [212], [410], [412], [610], [612], [810], [812] having a second spectral power distribution being different than the first spectral power distribution. Step [930] of the example [900] of the lighting process includes causing the semiconductor light-emitting device [104], [304], [504], [704] to emit the light emissions [204], [206], [404], [406], [604], [606], [804], [806] having the first spectral power distribution.

In some examples [900] of the lighting process, providing the lighting system [100], [300], [500], [700] at step [920] may further include providing the volumetric lumiphor [108], [308], [508], [708] as having an exterior surface [452], [652], [852] that includes a concave exterior surface [658] forming a gap between the semiconductor light-emitting device [104], [304], [504], [704] and the volumetric lumiphor [108], [308], [508], [708]. In those examples, step [940] of the example [900] of the lighting process may include causing some of the light emissions [204], [206], [404], [406], [604], [606], [804], [806] from the semiconductor light-emitting device [104], [304], [504], [704] having the first spectral power distribution to enter into the volumetric lumiphor [108], [308], [508], [708] through the concave exterior surface [658]; and causing some of the light emissions [204], [206], [404], [406], [604], [606], [804], [806] having the first spectral power distribution to be refracted by the volumetric lumiphor [108], [308], [508], [708]. In those examples, the example [900] of the lighting process may then end at step [950].

In additional examples [900] of the lighting process, providing the lighting system [100], [300], [500], [700] at step [920] may further include providing the volumetric lumiphor [108], [308], [508], [708] as having an exterior surface [452], [652], [852] that includes a convex exterior surface [664] being located at a distance away from and surrounding the central axis [202], [402], [602], [802]. In those examples, step [940] of the example [900] of the lighting process may include causing some of the light emissions [204], [206], [210], [212], [404], [406], [410], [412], [604], [606], [610], [612], [804], [806] [810], [812] having the first and second spectral power distributions to enter into and to be emitted from the volumetric lumiphor [108], [308], [508], [708] through the convex exterior surface [664]; and causing some of the light emissions having the first and second spectral power distributions to be refracted by the volumetric lumiphor [108], [308], [508], [708]. In those examples, the example [900] of the lighting process may then end at step [950].

In further examples [900] of the lighting process, providing the lighting system [100], [300], [500], [700] at step [920] may further include providing the volumetric lumiphor [108], [308], [508], [708] as having an exterior surface [452], [652], [852] that includes a concave exterior surface [864] being located at a distance away from and surrounding the central axis [202], [402], [602], [802]. In those examples, step [940] of the example [900] of the lighting process may include causing some of the light emissions [204], [206], [210], [212], [404], [406], [410], [412], [604], [606], [610], [612], [804], [806] [810], [812] having the first and second spectral power distributions to enter into and be emitted from the volumetric lumiphor [108], [308], [508], [708] through the concave exterior surface [864]; and causing some of the light emissions having the first and second spectral power distributions to be refracted by the volumetric lumiphor [108], [308], [508], [708]. In those examples, the example [900] of the lighting process may then end at step [950].

In other examples [900] of the lighting process, providing the lighting system [100], [300], [500], [700] at step [920] may further include providing a visible light reflector [106], [306], [506], [706] having a reflective surface [208], [408], [608], [808] and being spaced apart along the central axis [202], [402], [602], [802] at a distance away from the semiconductor light-emitting device [104], [304], [504], [704], with the volumetric lumiphor [108], [308], [508], [708] being located along the central axis [202], [402], [602], [802] between the semiconductor light-emitting device [104], [304], [504], [704] and the visible light reflector [106], [306], [506], [706]. In those examples of the example [900] of the lighting process, step [935] may include causing the reflective surface [208], [408], [608], [808] of the visible light reflector [106], [306], [506], [706] to reflect a portion of the light emissions [204], [206], [210], [212], [404], [406], [410], [412], [604], [606], [610], [612], [804], [806], [810], [812] having the first and second spectral power distributions. Further in those examples, step [935] of the lighting process [900] may additionally include permitting another portion of the light emissions [204], [206], [210], [212], [404], [406], [410], [412], [604], [606], [610], [612], [804], [806], [810], [812] having the first and second spectral power distributions to be transmitted through the visible light reflector [106], [306], [506], [706] along the central axis [202], [402], [602], [802]. In those examples, the process [900] may then end at step [950]. In these other examples of the example [900] of the lighting process, providing the lighting system [100], [300], [500], [700] at step [920] may further include providing the reflective surface [208], [408], [608], [808] of the visible light reflector [106], [306], [506], [706] as including a mound-shaped reflective surface [656]. Also in these other examples of the example [900] of the lighting process, providing the lighting system [100], [300], [500], [700] at step [920] may further include providing the exterior surface [452], [652], [852] of the volumetric lumiphor [108], [308], [508], [708] as including a concave exterior surface [654] being configured for receiving the mound-shaped reflective surface [656] of the visible light reflector [106], [306], [506], [706].

It is understood that step [920] of the example [900] of the lighting process may include providing the lighting system [100], [300], [500], [700] as having any of the features or any combination of the features that are disclosed herein in connection with discussions of the examples [100], [300], [500], [700] of implementations of the lighting system. Accordingly, FIGS. 1-8 and the entireties of the earlier discussions of the examples [100], [300], [500], [700] of lighting systems are hereby incorporated into this discussion of the examples [900] of the lighting process.

The examples [100], [300], [500], [700] of lighting systems and the example [900] of the lighting process may generally be utilized in end-use applications where light is needed having a selected perceived color point and brightness. The examples [100], [300], [500], [700] of lighting systems and the example [900] of the lighting process provided herein may, for example produce light emissions wherein the directions of propagation of a portion of the light emissions constituting at least about 50% or at least about 80% of a total luminous flux of the semiconductor light-emitting device or devices are redirected by and therefore controlled by the lighting systems. The controlled light emissions from these lighting systems [100], [300], [500], [700] and the lighting process [900] may have, as examples: a perceived uniform color point; a perceived uniform brightness; a perceived uniform appearance; and a perceived aesthetically-pleasing appearance without perceived glare. The controlled light emissions from these lighting systems [100], [300], [500], [700] and the lighting process [900] may further, as examples, be utilized in generating specialty lighting effects being perceived as having a more uniform appearance in applications such as wall wash, corner wash, and floodlight. The lighting systems [100], [300], [500], [700] and the lighting process [900] provided herein may further, for example, protect the lumiphors of the lighting systems from heat-induced degradation that may be caused by heat generated during light emissions by the semiconductor light-emitting devices, resulting in, as examples: a stable color point; and a long-lasting stable brightness. The light emissions from these lighting systems may, for the foregoing reasons, accordingly be perceived as having, as examples: a uniform color point; a uniform brightness; a uniform appearance; an aesthetically-pleasing appearance without perceived glare; a stable color point; and a long-lasting stable brightness.

### Example

A simulated lighting system is provided that variably includes some of the features that are discussed herein in connection with the examples of the lighting systems [100], [300], [500], [700] and the example [900] of the lighting process, such features variably including: a semiconductor light-emitting device (SLED) being a source of Lambertian light emissions having a diameter at the source of 19 millimeters; a volumetric lumiphor having a concave exterior surface that is located at a distance away from and surrounding the central axis of the lighting system; a visible light reflector; and a primary visible light reflector that includes a truncated parabolic reflector. In a first part of the simulation, the volumetric lumiphor and the visible light reflector are omitted; and the primary visible light reflector defines an image plane of light emissions from the lighting system having a diameter of 167 millimeters at a distance of 145 millimeters away from the SLED, with a resulting beam angle of 15.77 degrees. In simulated operation of this lighting system with the SLED at a total source power of 1.4716 watts, a total power of 0.368345 watts of the light emissions directly reaches the image plane without being reflected by the primary visible light reflector, being about 25.034% of the light emissions from the SLED. In a second part of the simulation, the volumetric lumiphor and the visible light reflector are omitted; and the primary visible light reflector defines an image plane of light emissions from the lighting system having a diameter of 108 millimeters at a distance of 88 millimeters away from the SLED, with a resulting beam angle of 21.8 degrees. In simulated operation of this lighting system with the SLED at a total source power of 1.4716 watts, a total power of 0.403 watts of the light emissions directly reaches the image plane without being reflected by the primary visible light reflector, being about 27.4% of the light emissions from the SLED. In a third part of the simulation, the volumetric lumiphor and the visible light reflector are included; and the primary visible light reflector defines an image plane of light emissions from the lighting system having a diameter of 108 millimeters at a distance of 88 millimeters away from the SLED, with a resulting beam angle of 15.63 degrees. In simulated operation of this lighting system with the SLED at a total source power of 1.4716 watts, a total power of 0.0 watts of the light emissions directly reaches the image plane without being reflected by the primary visible light reflector.

While the present invention has been disclosed in a presently defined context, it will be recognized that the present teachings may be adapted to a variety of contexts consistent with this disclosure and the claims that follow. For example, the lighting systems and processes shown in the figures and discussed above can be adapted in the spirit of the many optional parameters described.

1. A lighting system, comprising:
a light source including a semiconductor light-emitting device, the semiconductor light-emitting device being configured for emitting, along a central axis, light emissions having a first spectral power distribution;
a visible light reflector having a reflective surface and being spaced apart along the central axis at a distance away from the semiconductor light-emitting device;
a volumetric lumiphor being located along the central axis between the semiconductor light-emitting device and the visible light reflector, and being configured for converting some of the light emissions having the first spectral power distribution into light emissions having a second spectral power distribution being different than the first spectral power distribution;
wherein the reflective surface of the visible light reflector is configured for causing a portion of the light emissions having the first and second spectral power distributions to be reflected by the visible light reflector; and
wherein the visible light reflector is configured for permitting another portion of the light emissions having the first and second spectral power distributions to be transmitted through the visible light reflector along the central axis.

2-86. (canceled)
